(19) United States
(12) Patent Application Publication
(10) Pub. No.: US 2026/0267967 A1
(43) Pub. Date: Sep. 10, 2026

(54) SYSTEM AND METHOD FOR DIRECTORY RESTORATION FOR RANSOMWARE MITIGATION

(71) Applicant: EON IO Ltd., Tel Aviv (IL)

(72) Inventors: Lior Lev Tov, Bat Yam (IL); Assaf Natanzon, Tel Aviv (IL); Ron Kimchi, Tel Aviv (IL); Erez Reuven, Raanana (IL)

(73) Assignee: EON IO Ltd., Tel Aviv (IL)

(21) Appl. No.: 19/071,306

(22) Filed: Mar. 5, 2025

(51) Int. Cl. G06F 21/55; G06F 21/56

(52) U.S. Cl. CPC G06F 21/554; G06F 21/565; G06F 2221/034

(57) ABSTRACT

In one embodiment, a method comprises receiving a request to restore a directory of a file system, the directory comprising a plurality of files, the request comprising a threshold for a probability of file non-corruption; selecting versions of the plurality of files of the directory based on the threshold and probabilities of file non-corruption of the versions of the plurality of files at multiple points in time; and generating a representation of a restored version of the directory, wherein the restored version of the directory includes the selected versions of the plurality of files.

### TECHNICAL FIELD

This disclosure relates in general to the field of data backup and recovery and, more particularly, to directory restoration for ransomware mitigation.

### BACKGROUND

Cloud data backup is the process of creating and storing copies of data in a remote, cloud-based environment to ensure data availability, protection, and recovery in case of failure or data loss. While organizations may utilize traditional on-premises backups, cloud backups offer greater flexibility and scalability, allowing businesses to adjust storage as needed and access their data from anywhere with an internet connection. Cloud backups typically provide automated processes, encryption, and redundancy across multiple servers, enhancing both security and reliability. This ensures that businesses can recover their data quickly, minimizing downtime and mitigating the risk of data breaches or corruption. Cloud data backup may also be the most efficient way to backup workloads which are running natively in the cloud.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a block diagram of a cloud data backup environment, in accordance with any of the embodiments disclosed herein.

FIG. 2 illustrates a block diagram of a backend of a cloud backup service provider of the environment of FIG. 1, in accordance with any of the embodiments disclosed herein.

FIG. 3 illustrates a block diagram of a computing device of FIG. 1, in accordance with any of the embodiments disclosed herein.

FIG. 4 illustrates an example data backup sequence, in accordance with any of the embodiments disclosed herein.

FIG. 5 illustrates a storage backup log for a multiple point-in-time file system explorer, in accordance with any of the embodiments disclosed herein.

FIG. 6 illustrates a multiple point-in-time file system explorer, in accordance with any of the embodiments disclosed herein.

FIG. 7 illustrates a flow for updating a storage backup log for a multiple point-in-time file system explorer, in accordance with any of the embodiments disclosed herein.

FIG. 8 illustrates a flow for providing a multiple point-in-time file system explorer, in accordance with any of the embodiments disclosed herein.

FIG. 9 illustrates a storage backup log for a multiple point-in-time file system explorer for ransomware mitigation, in accordance with any of the embodiments disclosed herein.

FIG. 10 illustrates a multiple point-in-time file system explorer for ransomware mitigation, in accordance with any of the embodiments disclosed herein.

FIG. 11 illustrates a multiple point-in-time file system explorer with filtering capabilities for ransomware mitigation, in accordance with any of the embodiments disclosed herein.

FIG. 12 illustrates a flow for updating a storage backup log for a multiple point-in-time file system explorer for ransomware mitigation, in accordance with any of the embodiments disclosed herein.

FIG. 13 illustrates a flow for providing a multiple point-in-time file system explorer for ransomware mitigation, in accordance with any of the embodiments disclosed herein.

FIG. 14 illustrates a storage backup log for directory restoration for ransomware mitigation, in accordance with any of the embodiments disclosed herein.

FIG. 15 illustrates a flow for directory restoration based on a minimum clean probability, in accordance with any of the embodiments disclosed herein.

FIG. 16 illustrates a flow for directory restoration based on a preferred restore probability and a minimum restore probability, in accordance with any of the embodiments disclosed herein.

FIG. 17 illustrates a flow for directory restoration based on a keep probability and a replacement probability, in accordance with any of the embodiments disclosed herein.

FIG. 18 illustrates a flow for in-place directory restoration based on a source keep probability and a target replacement probability, in accordance with any of the embodiments disclosed herein.

### DETAILED DESCRIPTION OF EXAMPLE EMBODIMENTS

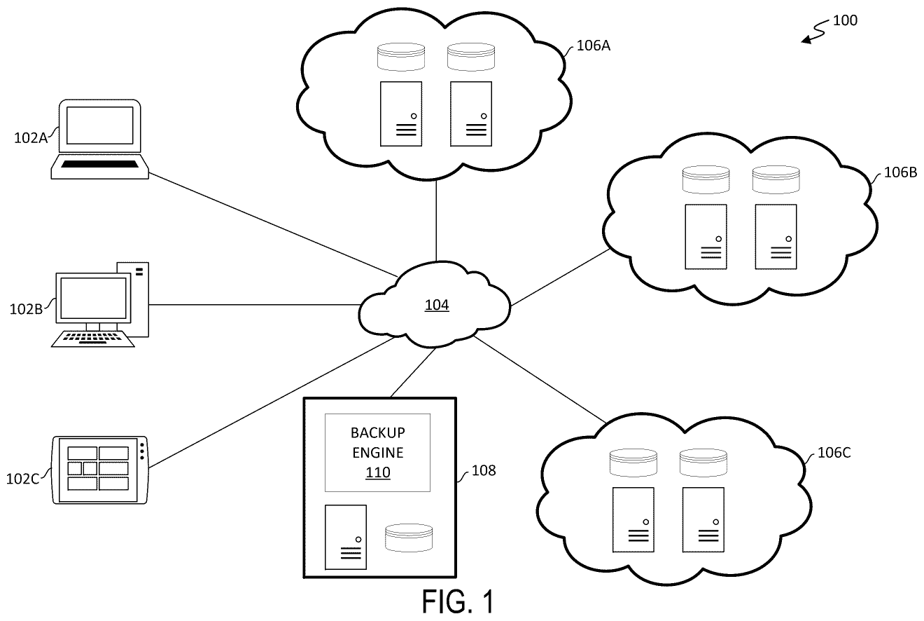

FIG. 1 illustrates a block diagram of a cloud data backup environment 100, in accordance with any of the embodiments disclosed herein. An organization (e.g., any one or more users associated with each other) may utilize any number of storage collections with file systems that include data (e.g., directories and files) accessed by users associated with the organization. The users may interact with the data using computing devices 102 (e.g., 102A, 102B, 102C).

The data may be stored (temporarily or persistently) at a site owned or leased by the organization (e.g., “on premises”), at another location (e.g., owned or managed by a cloud service provider), or at multiple locations. The data of an organization may be backed up in the cloud, e.g., within a backend 106 (e.g., 106A, 106B, 106C) of a cloud backup service provider, across multiple backends of the same cloud backup service provider, at one or more backends of a different cloud backup service provider, at another suitable location (e.g., at a local site or device of the organization), or any combination thereof (e.g., some data may be backed up at backend 106A, other data may be backed up at backend 106B, and some data may be backed up at a local site). In some instances, the organization may also have data that is not backed up (but rather stored locally, in the cloud, or otherwise). In various embodiments, a storage location including data is stored that is backed up at a different location (e.g., a backup storage location) may be referred to herein as a source storage location.

When a user is navigating within a file explorer in a file system that has been backed up (e.g., in the cloud, in on-premises storage, in a portable hard drive, etc.), the view of the directories and files within the file explorer are typically limited to a single point-in-time. For example, the user may view the current directories and files or may view the directories and files that are backed up by a particular instance of a series of backups. Accordingly, it may be difficult for a user to understand the history of the directories and files without manually navigating through each backup. Moreover, a file may have been deleted at some point and if the user does not know the name of the file (or the backup utility does not support searching by file name across the different backups), the user may have to manually browse multiple backups in order to locate the file.

Various embodiments provide a multiple point-in-time file system explorer that provides a view of a file system at multiple points in time simultaneously. Through this explorer, a user may be provided a wholistic view of the evolution of the file system. In some embodiments, a reference point-in-time may be specified (e.g., by the user) and the file system explorer may display the directories and files from the perspective of the reference point-in-time. Directories and files that were (or are) in existence at the reference point-in-time may be displayed in a first format (e.g., a standard format). However, the file system explorer may also display directories and files that were deleted prior to the reference point-in-time and/or directories and files that were created after the reference point-in-time. In some instances, these directories and files may be formatted differently from the directories and files that are in existence at the reference point-in-time to enable the user to easily detect changes that occurred prior to and/or after the reference point-in-time. Thus, a user may browse the file system at multiple points in time simultaneously, greatly enhancing the ability of the user to locate desired files or directories that have changed over time.

Some embodiments provide a multiple point-in-time file system explorer for ransomware mitigation. Ransomware is a type of malicious software (malware) that encrypts a victim's files or locks them out of their system, rendering the data or system inaccessible. The attacker then demands a ransom from the victim to restore access to the data or system. Ransomware may target a computing system (e.g., 102) using any suitable attack vectors, such as phishing emails, malicious websites, remote desktop protocol, or software vulnerabilities. While regular backups of a storage collection may mitigate the risk of losing files to ransomware, if the ransomware encrypts files over a long period of time (e.g., in order to avoid immediate detection), the last clean backup may be too old or it may be difficult for the user to identify clean versions of the files that the user would like to restore (e.g., the clean versions may be spread out among numerous backups at different points in time). The user may spend an inordinate amount of time choosing the correct backup for each file and verifying that the file is not corrupt.

Various embodiments provide a multiple point-in-time file system explorer that displays identifiers of files as well as the point-in-time of the backup of the last known good copy of the files if the files are likely to be corrupt. A file system explorer may display indications of files with corresponding different points in time if the files were corrupted at different times. Such a file system explorer may allow a user to quickly identify and restore uncorrupted versions of files that have become corrupt via ransomware (or other malicious or harmful means). Thus, in some embodiments, the multiple point-in-time file system explorer presents at least a portion of a file system to the user from the point of view of the last backup (or other point of time of another selected backup), but for files that are detected as corrupt, the explorer may present the latest good point in time for those files.

Various embodiments provide systems and methods for restoring a directory to mitigate ransomware attacks based on thresholds are provided. In one embodiment, a request may include a threshold representing a minimum clean threshold that is compared against ransomware clean probabilities of versions of the files in the directory and, for each file, the most recent version that has a ransomware clean probability that is above the minimum clean threshold is included in the restored directory. In various embodiments, a request may include first and second thresholds. In one embodiment, the first threshold is a preferred restore probability and the second threshold is a minimum restore probability. The restored directory may include the most recent version of the file that has a ransomware clean probability that is greater than the first threshold or (if no such version exists) the most recent version of the file that has a ransomware clean probability that is greater than the second threshold. In another embodiment, the first threshold is a keep probability and the second threshold is a replacement probability. If the current version of a file is greater than the first probability, then the version will not be replaced in the restored directory. If the current version of the file has a ransomware clean probability that is not greater than the first probability, then the most recent version of the file that has a ransomware clean probability is greater than the second threshold may be included in the restored directory. In any of these various embodiments, the directory may be restored in-place (e.g., at the source storage location) or to a different location (e.g., at the backup storage location or to a different storage location).

Various embodiments may provide one or more technical advantages such as faster identification or restoration of files or directories, decreased usage of computing and/or network resources (e.g., power, bandwidth) when searching for, accessing, and/or restoring files or directories, or other technical advantages.

In the depicted embodiment, the cloud data backup environment 100 includes a data backup and search system 108. The data backup and search system 108 may provide any suitable features of the embodiments of the multiple point-in-time file system explorer described herein. In some embodiments, the data backup and search system 108 may include a backup engine 110 that is to detect initiations of backups and, in response, record changes of the data collection backed up by the backup in a storage backup log (e.g., as described below). The backup engine 110 may also perform the actual backup as well and/or may communicate with other logic to perform the backup. In various embodiments, backup engine 110 may be included, in whole or in part, within the data backup and search system 108, within a backend 106, at a computing device 102, at another suitable location within cloud data backup environment 100, or at any combination thereof. The backup engine 110 may be implemented by one or more computing devices, such as computing device 300 described below.

In various embodiments, any of the features of the multiple point-in-time file system explorer or a subset thereof may be performed by any other suitable logic, such as computing devices within one of the backends 106, by a computing device 102 (e.g., through a web application or native application that interfaces with the data backup and search system 108), by other suitable logic, or by any suitable combination of these and/or the data backup and search system 108.

The data backup and search system 108 may receive requests from one or more computing devices 102 over network 104 to backup data and in response may initiate backups in one or more of backends 106 (or other locations) as well as store data representing changes across the various backups at different points in time to provide the multiple point-in-time file system explorer. The data backup and search system 108 may also interact with the computing devices 102 to provide the multiple point-in-time file system explorer. For example, the data backup and search system 108 may receive input from a user browsing backed up data in a multiple point-in-time file system explorer on a computing device 102 and may update the view provided to the user based on the input from the user and the data representing the changes in the backups at the multiple points in time. The data backup and search system 108 may also be operable to restore (or at least initiate restoration of) data from backups based on requests from users made in the multiple point-in-time file system explorer.

Data backup and search system 108 may include any suitable number of computing devices to perform the functions described herein. In a particular embodiment, the data backup and search system 108 may comprise a cluster of nodes (e.g., physical or virtual machines) in a Kubernetes environment, although any suitable computing environment may be used to implement the data backup and search system 108. The data backup and search system 108 may include and/or manage a plurality of accounts, where a particular account may be associated with (e.g., owned or controlled by) a particular organization. Data used to provide the multiple point-in-time file system explorer (e.g., storage backup logs) for a particular organization may be stored in the account owned by that organization. In various embodiments, the data backup and search system 108 may be separate from the backends 106 or could be implemented (at least in part) within one of the backends 106.

Computing devices 102 may include any electronic computing device operable to receive, transmit, process, and store any appropriate data. In various embodiments, computing devices 102 may be mobile devices or stationary devices. As examples, mobile devices may include laptop computers, tablet computers, smartphones, personal digital assistants, and other devices capable of connecting (e.g., wirelessly) to network 104 while stationary devices may include desktop computers or other devices that are not easily portable. Computing devices 102 may include a set of programs such as operating systems (e.g., Microsoft Windows, Linux, Android, Mac OSX, Apple iOS, UNIX, or other operating system), applications, and other software-based programs capable of being run, executed, or otherwise used by the respective devices. A computing device may include at least one graphical display and user interface allowing a user to view and interact with applications and other programs of the computing device to perform operations associated with one or more data (e.g., searching for data, modifying data contents, reading data contents, initiating data backups, etc.).

FIG. 1 also depicts a network 104 that couples the computing devices 102, backends 106, and data backup and search system 108 together. The network 104 may transport communications between computing devices 102, the various backends 106, and the data backup and search system 108.

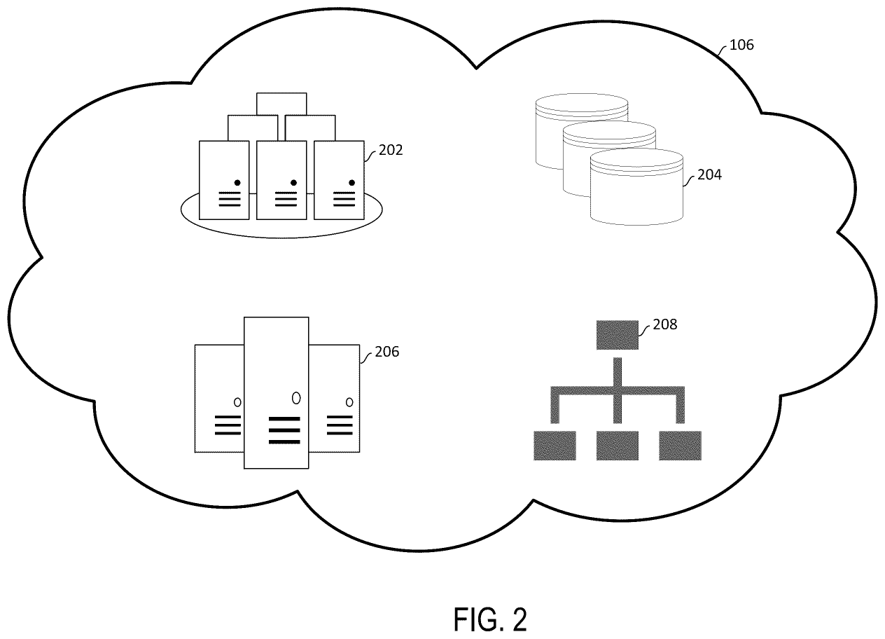

FIG. 2 illustrates a block diagram of a backend 106 of a cloud backup service provider of the environment of FIG. 1, in accordance with any of the embodiments disclosed herein. Backend 106 may include various computing systems to provide services (including data backup services) to various organizations. In the embodiment depicted, backend 106 includes compute resources 202, storage resources 204, operations computing systems 206, and networking resources 208.

Compute resources 202 may include hardware components used to provide cloud services, such as general-purpose processors (e.g., central processing units (CPUs), server processors, accelerated processing units (APUs), controllers), specialized processors (e.g., graphics processing units (GPUs), application-specific integrated circuits (ASICs), digital signal processors (DSPs), field programmable gate arrays (FPGAs), neural network processing units (NPUs), data processor units (DPUs), controller cryptoprocessors (specialized processors for cryptographic algorithms)), or accelerators (e.g., graphics accelerators, compression accelerators, artificial intelligence accelerators), or other hardware components.

Storage resources 204 may provide the storage and retrieval of data (e.g., data (including backups) or associated data). Storage resources 204 may include hardware, such as hard disk drives, solid-state drives, tape storage, or other suitable mechanisms for storing data. Storage resources 204 may store any suitable data in any suitable format(s). For example, storage resources 204 may provide object, block, or file storage.

Operations computing systems 206 may include any suitable computing systems to manage the various operations of the backend, such as coordination of incoming and outgoing communications; allocation of compute, storage, and networking resources; monitoring of usage; application deployment; enforcement of security (e.g., identity and access management (IAM), encryption and key management, intrusion detection), and other management tasks.

Networking resources 208 may include any suitable hardware or software to facilitate communication among compute resources 202, storage resources 204, and/or other cloud resources of the backend. Networking resources 208 may include, e.g., routers, switches, firewalls, load balancers, gateways, edge devices, network interface cards, and other suitable networking hardware.

The compute resources 202, storage resources 204, and networking resources 208 may be used to provide compute services to clients of the service provider, such as virtual machines, containers, bare metal servers, or serverless computing.

In various embodiments, a backend 106 is managed by a third party. For example, a backend 106 may be deployed using a cloud service such as Amazon Web Services, Microsoft Azure, or Google Cloud Platform. A backend 106 may provide services to organizations using any suitable service model, such as infrastructure as a service (IaaS), platform as a service (PaaS), or software as a service (SaaS), or combinations thereof.

In IaaS, on-demand access is provided to essential information technology (IT) infrastructure, such as servers, storage, and networking, over a virtual interface. Users do not need to manage or maintain physical infrastructure, as it is hosted and managed by the cloud service provider. While the provider handles the underlying hardware and maintenance, users retain control over operating systems, storage, and applications they deploy. This eliminates the need for organizations to manage on-premises infrastructure, offering flexibility and scalability.

In PaaS, a development and deployment environment is provided, including the necessary infrastructure and software tools, for creating and managing applications. Users can develop and run cloud-based applications without managing the underlying infrastructure, such as servers, networks, and storage. PaaS is typically accessed on a pay-as-you-go basis and allows users to focus on application deployment and management, while the cloud provider handles the infrastructure and software maintenance.

In SaaS, users access cloud-based applications provided and maintained by a service provider. Instead of installing software locally, users access the applications via the web or application programming interface (API) on a subscription basis. In this model, the service provider oversees the hardware, software, middleware, and security, eliminating the need for end users to manage or update the software themselves.

An organization may utilize one or more backends 106 to provide data backup for the organization. Data backup is the process of creating a copy of the data that can be used to restore the data in case of data loss, corruption, or other disasters. Backups are essential for data protection, disaster recovery, and ensuring business continuity.

Various types of backups may be performed on the data of an organization. In a full backup, a complete copy of the entire data collection covered by the backup is saved in the backup storage. This is the most comprehensive type of backup but can be time consuming and storage intensive. In an incremental backup, only the data that has changed since the last backup on the data collection (either full or incremental) is saved in the backup storage. This reduces the amount of data to be backed up and speeds up the backup process. In a differential backup, all of the data that has changed in the data collection since the last full backup is saved in the backup storage. This is faster than a full backup but can grow in size over time until the next full backup.

An organization may utilize various backup strategies (and could utilize different backup strategies for different data collections). For example, in a full backup strategy, full backups are regularly performed. This strategy may be suitable for small data where backup time and storage size are not significant concerns. In an incremental backup strategy, a full backup may be performed periodically (e.g., weekly) and incremental backups are performed more often (e.g., daily). This reduces backup time and storage requirements. In a differential backup strategy, a full backup is performed periodically (e.g., weekly) and differential backups are performed more often (e.g., daily). This strategy provides a balance between backup time and storage. In a mixed strategy, various types of strategies (e.g., full, incremental, and transaction log backups) may be combined to optimize backup and recovery times.

An organization may utilize any suitable data backup tool to implement their desired backup strategies and to create data backups that are stored on a backend 106 or other location. Various such tools include, e.g., rsync (a command-line utility for Unix-based systems that synchronizes files and directories between two locations), tar (a Unix utility used to create archive files), Bacula, Amanda, Veeam, and Acronis.

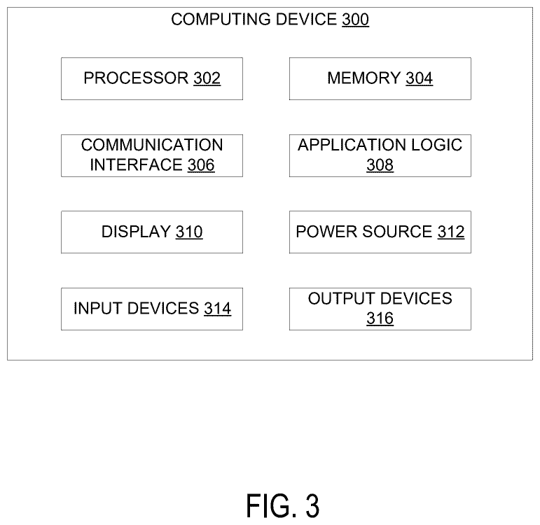

FIG. 3 illustrates a block diagram of a computing device 300, in accordance with any of the embodiments disclosed herein. One or more computing devices 300 (or portions or alternatives thereof) may be used to implement a computing device 102, one or more portions of data backup and search system 108, or one or more portions of backends 106. As used in this document, the term computing device is intended to encompass any suitable processing device. A computing device 300 may be operable to receive, transmit, process, store, or manage data and information associated with cloud data backup environment 100.

In the depicted embodiment, computing device 300 includes one or more processors 302, memories 304, communication interfaces 306, application logic 308, display 310, power source 312, input devices 314, and output devices 316, among other hardware and software. These components may work together in order to provide any suitable functionality described herein.

A processor 302 may be any suitable computing device, resource, or combination of hardware, stored software and/or encoded logic operable to provide, either alone or in conjunction with other components of computing device 300, the functionality of the computing device. In particular embodiments, computing device 300 may utilize multiple processors to perform the functions described herein. In various embodiments, processor 302 may include one or more general-purpose processors (e.g., CPUS, server processors, APUs, controllers), specialized processors (e.g., GPUs, general-purpose GPUs, ASICs, DSPs, FPGAs, NPUs, DPUs, controller cryptoprocessors (specialized processors for cryptographic algorithms)), or accelerators (e.g., graphics accelerators, compression accelerators, artificial intelligence accelerators).

A processor can execute any type of instructions to achieve the operations detailed in this specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array (FPGA), an erasable programmable read only memory (EPROM), an electrically erasable programmable ROM (EEPROM)) or an application specific integrated circuit (ASIC) that includes digital logic, software, code, electronic instructions, or any suitable combination thereof.

Memory 304 may comprise any form of non-volatile or volatile memory including, without limitation, random access memory (RAM), read-only memory (ROM), magnetic media (e.g., one or more disk or tape drives), optical media, solid state memory (e.g., flash memory), removable media, or any other suitable local or remote memory component or components. Memory 304 may store any suitable data or information utilized by a computing device 300, including software embedded in a (e.g., non-transitory) computer readable medium, and/or encoded logic incorporated in hardware or otherwise stored (e.g., firmware). Memory 304 may also store the results and/or intermediate results of the various calculations and determinations performed by processor 302.

Communication interface 306 may be used for the communication of signaling and/or data between computing devices and one or more networks and/or network nodes coupled to a network or other communication channel. For example, communication interface 306 may be used to send and receive network traffic such as data packets. Each communication interface 306 may send and receive data and/or signals according to a distinct standard such as an LTE, IEEE 802.11, IEEE 802.3, or other suitable standard. In some instances, communication interface 306 may include antennae and other hardware for transmitting and receiving radio signals to and from other devices in connection with a wireless communication session over one or more networks.

Application logic 308 may include logic providing, at least in part, the functionality of the computing device. In a particular embodiment, the logic of a computing device 300 may include software (e.g., a web browser, an application, an operating system, etc.) that is executed by processor 302. However, “logic” as used herein, may include but not be limited to hardware, firmware, software and/or combinations of each to perform a function(s) or an action(s), and/or to cause a function or action from another logic, method, and/or system. In various embodiments, logic may include a software controlled microprocessor, discrete logic (e.g., an application specific integrated circuit (ASIC)), a programmed logic device (e.g., a field programmable gate array (FPGA)), a memory device containing instructions, combinations of logic devices, or the like. Logic may include one or more gates, combinations of gates, or other circuit components. Logic may also be fully embodied as software.

Display 310 may include one or more embedded or connected (e.g., via a wired or wireless connection) external visual indicators, such as a computer monitor, a touchscreen display, a liquid crystal display (LCD), a light-emitting diode display, or a flat panel display.

Power source 312 may include one or more energy storage devices (e.g., batteries or capacitors) and/or circuitry for coupling components of the computing device 300 to an energy source separate from the computing device 300 (e.g., alternating current line power).

An input device 314 may accept input from a source external to the computing device 300. Examples of input devices 314 may include an image capture device, keyboard, cursor control device, touchscreen, and an audio device (e.g., microphone), to name a few.

An output device 316 may output signals based on information provided by computing device 300. Examples of output devices 316 include an audio device (e.g., a speaker), an audio codec, a video codec, a printer, a transmitter for providing information to other devices, a storage device, to name a few.

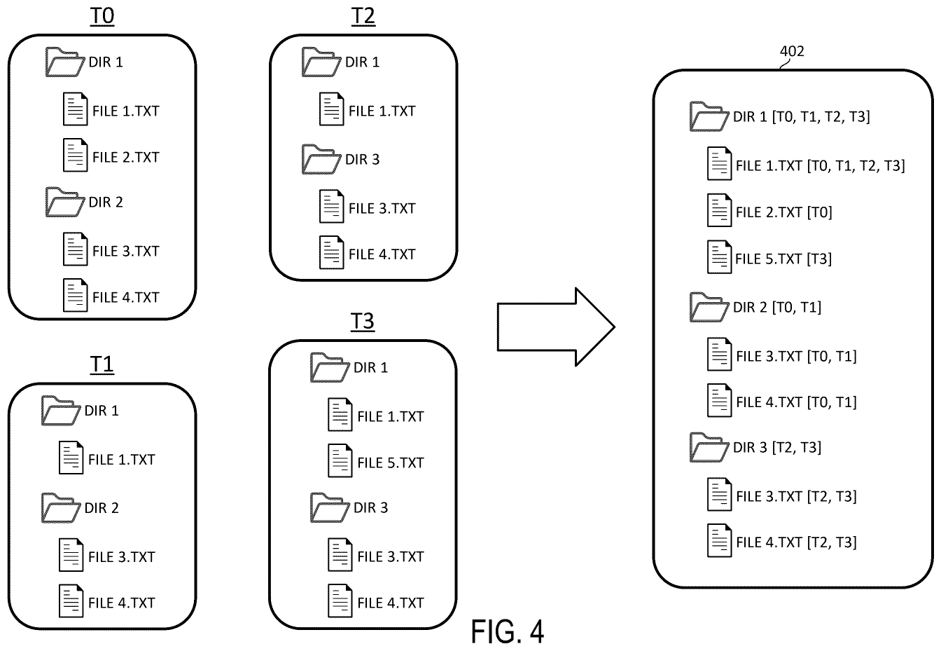

FIG. 4 illustrates an example data backup sequence, in accordance with any of the embodiments disclosed herein. This sequence shows the evolution of files and directories of a particular path and a multiple point-in-time file system explorer 402.

When a first backup of a storage collection is performed at time T0, the path of the source storage device that is to be backed up (e.g., the root directory) includes a first directory DIR 1 which includes a first file FILE 1.TXT and a second file FILE 2.TXT as well as a second directory DIR 2 which includes a third file FILE 3.TXT and a fourth file FILE 4.TXT.

In between time T0 and the next storage backup performed at time T1, FILE 2.TXT is deleted at the source storage device. Then, prior to the next storage backup performed at time T2, the directory DIR 2 is renamed to DIR 3. Finally, a fifth file FILE 5.TXT is added to the directory DIR 1 prior to the storage backup performed at T3.

Responsive to the backups, the data backup and search system 108 may store associations between the files and directories present during each of the backups and the points in time of the backups. These stored associations may enable provision of the multiple point-in-time file system explorer. Thus, for directory DIR 1, the multiple point-in-time file system explorer 402 indicates that DIR 1 and FILE 1.TXT were present in the backups at times T0, T1, T2, and T3, FILE 2.TXT was present at time T0, and FILE 5.TXT was present at T3. As depicted, DIR 2 and its files FILE 3.TXT and FILE 4.TXT were present at times T0 and T1. DIR 3 and its files FILE 3.TXT and FILE 4.TXT were present at times T2 and T3.

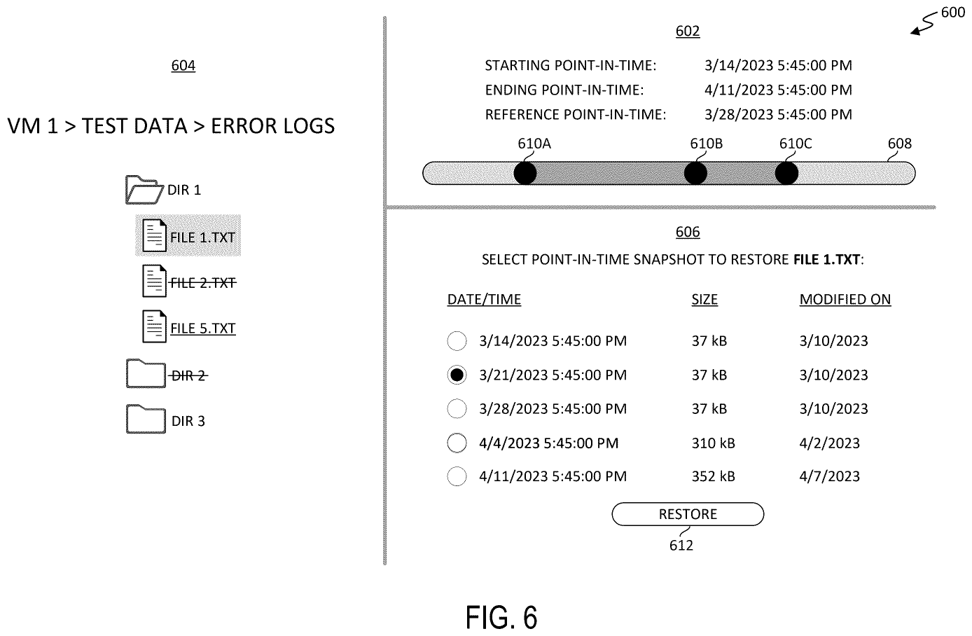

As depicted, the multiple point-in-time file system explorer 402 may be displayed in a format in which the directory names and file names are displayed along with indications of the points in time of the backups that include the directories and files. In some embodiments, the directories and files for all available backups may be presented within the multiple point-in-time file system explorer 402 and selecting a directory or file (e.g., with a right click of a mouse or other user activity) may result in a display of indications of the backups that include the selected directory or file (e.g., the indication may include the date and/or time of the backups or other temporal indication distinguishing the backups). An alternative interface for the multiple point-in-time file system explorer is described in connection with FIG. 6.

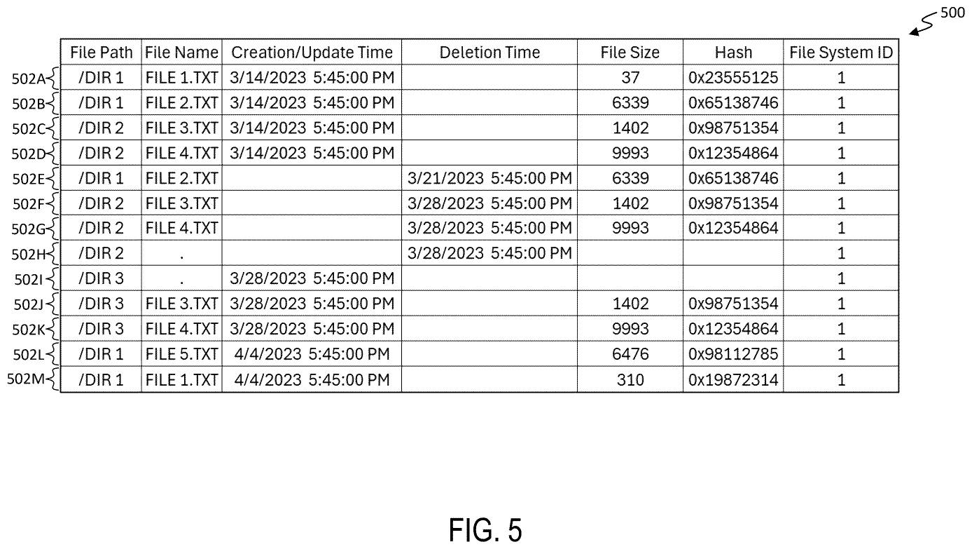

FIG. 5 illustrates a storage backup log 500 for a multiple point-in-time file system explorer, in accordance with any of the embodiments disclosed herein. In some embodiments, the storage backup log 500 may be stored at and/or maintained by data backup and search system 108, a backend 106, one or more computing devices 102, or other suitable logic. The storage backup log 500 may be updated each time a storage backup is performed. For example, in conjunction with performing a storage backup, the storage backup log 500 may be updated with changes that have been made to the files and directories covered by the backup relative to the most recent backup.

In this example, the storage backup log 500 is stored in a table of a relational database (e.g., a SQL database) in which each record 502 (e.g., row) of the storage backup log 500 corresponds to a change to a file or directory in the storage collection covered by the backup. A table may be a structured collection of related data organized in rows and columns. Each record (also referred to as a row) may represent a single entry in the table, while each column (also referred to as field or attribute) may represent a specific attribute of the data.

The records 502 in FIG. 5 track the sequence of FIG. 4. The log 500 includes columns including file path, file name, creation/update time, deletion time, file size, hash, and file system identifier (ID). In other embodiments, one or more of these columns may be omitted and/or the storage backup log 500 may include additional columns (e.g., a last modified column indicating the date/time the file or directory was last modified at the source or a created column indicating the date/time the file or directory was created at the source).

The file path may be a string that describes the location of a file or directory within a file system. It specifies the route or path to access the file, beginning from the root directory to the specific file or directory. The file path may be an absolute file path (e.g., a complete path from the root of the file system to the target file or directory) or a relative file path (e.g., a partial path starting from a directory other than the root directory). In the records 502 shown in FIG. 5, the file paths all start from a root directory represented by the “/” character.

The file name may be a specific name of a file and is typically expressed as a string (e.g., an alphanumeric string). The file name may also include an extension based on the type of the file (in this case “. TXT” for each file referenced in the storage backup log 500). When a record 502 corresponds to a directory (e.g., as is the case with records 502H and 502I), a default value (e.g., null, “.”, etc.) may be stored in the file name field.

The creation/update time may include a date and/or time at which the file or directory was created or updated (if the change indicated by the record was a creation or update of a file or directory, otherwise this field may be null or some other predetermined value). In other embodiments, separate columns could be used for creation time and updated time. The deletion time may include a date and/or time at which the file or directory was deleted (if the change indicated by the record was a deletion of a file or directory, otherwise this field may be null or some other predetermined value).

The file size includes a size of the file or directory (e.g., in kilobytes or other unit). The file sizes for the directories may be null (as shown) or may also be included in this field (not shown).

The hash is a string (e.g., of a fixed length) of characters generated from the contents of the file using a hash function (e.g., a message digest algorithm, a secure hash algorithm, a checksum, or other suitable hash function). The hash serves as a unique fingerprint or identifier for that file and may typically be used by the backup engine 110 to distinguish between different versions of the same file.

The file system ID represents an ID of a file system to which the file or directory belongs. In some instances, a backup of a storage collection (e.g., of one or more computing systems) may encompass multiple file systems. Accordingly, the file system ID allows differentiation between the files and directories of the various file systems.

In particular embodiments, the storage backup log 500 may be dedicated to a particular backup series of the same storage collection. For example, the storage backup log 500 may be dedicated to backups of a particular machine, volume, drive, or other storage collection made at different points in time. In other embodiments, the storage backup log 500 could be used for multiple different backup series of different storage collections (e.g., of different machines, drives, etc.). In such a case the storage backup log 500 could include an additional field that includes an identifier of the storage collection that is being backed up through the backup series (e.g., a machine name, network address, etc.).

When a storage collection is scanned in conjunction with a backup, each change in the storage device is identified and a record is made in the storage backup log 500 for the change. Such changes may include, e.g., a creation of a file or directory, a deletion of a file or directory, an update to contents of a file, a change in the title of a file or directory, and a change in the location of a file or directory. In various embodiments, a change in the location or title of a file or directory may be recorded in two records of the storage backup log 500, wherein a first record indicates a deletion of the file or directory in the previous location or with the previous title and a second record indicates a creation of the file or directory in the new location or with the new title.

Referring jointly to FIGS. 4 and 5, a first backup is performed on Mar. 14, 2023 at 5:45:00 PM (e.g., “T0”). If this backup is the first backup performed on the storage collection, then all files and directories may be detected as new and a record may be created for each file and directory that is backed up (where each record shows a creation of a file or directory). If the backup is not the first backup, then records 502 will be created for changes detected relative to the most recent backup on the storage device. In this instance, creation of FILE 1.TXT and FILE 2.TXT within/DIR 1 is detected and results in generation of records 502A and 502B. Similarly, creation of FILE 3.TXT and FILE 4.TXT within/DIR 2 is also detected and results in generation of records 502C and 502D. Each of records 502A-D includes a time of creation (3/14/2023 5:45:00 PM) equal to the time the backup is performed and no value (or a null value) in the deletion time column. These records also include respective file sizes and hash values as well as the same file system ID.

A second backup is performed on Mar. 21, 2023 at 5:45:00 PM (e.g., “T1”). The only change detected in this backup relative to the first backup is deletion of FILE 2.TXT. Accordingly, record 502E is added to the log to capture the deletion.

A third backup is performed on Mar. 28, 2023 at 5:45:00 PM (e.g., “T2”). In this backup, the changes relative to the second backup include the changing of the name of DIR 2 to DIR 3. Accordingly, records 502F and 502G recording the deletion of FILE 3.TXT and FILE 4.TXT within/DIR 2 are generated. Additionally, record 502H recording the deletion of/DIR 2 is also generated. Record 502I recording the creation of/DIR 3 is generated and records 502J and 502K recording the creation of FILE 3.TXT and FILE 4.TXT within/DIR 3 are also generated to complete the records capturing the renaming of/DIR 2 to/DIR 3.

A fourth backup is performed on Apr. 4, 2003 at 5:45:00 PM (e.g., “T3”). In the fourth backup, the changes relative to the third backup include the creation of FILE 5.TXT within/DIR 1 and an update to FILE 1.TXT within/DIR 1. Record 502L captures the addition of FILE 5.TXT and record 502M captures the update to FILE 1.TXT. As evidenced by records 502A and 502M, the file size of FILE 1.TXT has changed from 37 kB to 310 kB and the hash value has also changed. In various embodiments, the storage backup log 500 may include any other suitable fields, such as a file creation time, a file last modified field, or other suitable fields.

Storing the storage backup log 500 in a relational database may simplify provision of the multiple point-in-time file system explorer (although in various embodiments the storage backup log 500 may be stored in any suitable format). For example, when a user has selected a file path to view in the multiple point-in-time file system explorer 402, the storage backup log 500 may be searched (e.g., using one or more SELECT queries) using filters for the file path (and potentially other filters for the creation/update time and the deletion time) in order to obtain a list of files and directories across multiple points in time (that correspond to different backup versions). For example, all of the files that were created before or during a time span or a point-in-time specified by the user may be returned by one or more searches of the storage backup log 500 for display in the multiple point-in-time file system explorer 402. A search may also be made for files or directories that were deleted during the time span or at the point-in-time so that such files or directories may be marked as deleted in the multiple point-in-time file system explorer 402. Although not shown, in some embodiments, the records may be kept in storage backup log 500 by lexicographical order by file path (e.g., to improve query times).

FIG. 6 illustrates a multiple point-in-time file system explorer 600, in accordance with any of the embodiments disclosed herein. The multiple point-in-time file system explorer 600 may include any suitable characteristics of multiple point-in-time file system explorer 402 or vice versa.

In this embodiment, the multiple point-in-time file system explorer 600 may be provided (e.g., displayed) to a user of a computing device 102 through a web application (e.g., accessed through a web browser executed by a computing device 102), through a native application executed by the computing device 102, or by other suitable means.

The multiple point-in-time file system explorer 600 includes a point-in-time selector portion 602, a file system explorer portion 604, and a restoration portion 606. The point-in-time selector portion 602 allows the user to specify one or both of a reference point-in-time and a time range (defined by a starting point-in-time and an ending point-in-time). In the embodiment depicted, a slider bar 608 allows a user to slide one or more nodes 610 (e.g., 610A, B, C) across a range between the point-in-time of the earliest backup and the point-in-time of the most recent backup of a particular storage collection. In this embodiment, node 610A may select a starting point-in-time, node 610B may select a reference point-in-time, and node 610C may select an ending point-in-time. Each of these points in time are displayed above the slider bar 608. In other embodiments, the point-in-times may be specified via any other interface (e.g., a calendar interface, a text entry field, a selection from a list of available points in time, etc.).

The results shown in the file system explorer portion 604 may be based on the reference point-in-time and/or the time range. In one embodiment, a reference point-in-time is selected. The results shown in the file explorer portion 604 are formatted based on the reference point-in-time. For example, current files and directories in existence in the backup performed at the reference point-in-time are displayed in a first format, files and directories deleted prior to the reference point-in-time are displayed in a second format, and files and directories created after the reference point-in-time are displayed in a third format. The formats may be different from each other so as to allow current (e.g., files or directories in existence in the backup performed at the reference point-in-time), deleted, and future files and directories to be distinguished from each other. For example, in the embodiment depicted, the names of the current files and directories (e.g., in existence in the backup made at Mar. 28, 2023 5:45:00 PM) are shown in a standard font, the names of the file (FILE 2.TXT) and directory (DIR 2) that were deleted prior to the reference point-in-time are shown with strikeout formatting, and the name of the file (FILE 5.TXT) created after the reference point-in-time is shown with underline formatting. In various embodiments, any other suitable formatting may be used. For example, the names and/or icons representing the directories or directories may be displayed in different colors and/or may be highlighted using different colors or effects.

In some instances, a reference point-in-time is specified but a time range is not specified. In such instances, the time range for determining which deleted files and directories and future files and directories to display in file explorer portion 604 may include the points of time of all of the available backups for the storage collection. However, when a range is specified, the deleted files and directories and future files and directories displayed in file explorer portion 604 may be filtered based on the range. For example, files and directories deleted prior to the starting point-in-time as well as files and directories created after the ending point-in-time may be omitted from the file explorer portion 604.

When a file or directory is selected, hovered over by a mouse pointer, or receives other suitable interaction from the user, any suitable information associated with the file or directory may be displayed. In the embodiment depicted, FILE 1.TXT is selected as indicated by its background highlighting. Responsive to this selection, restoration portion 606 is displayed. Restoration portion 606 includes a list of the storage backups that include the selected file and the point-in-times of those backups. In various embodiments, the restoration portion 606 may be constructed (e.g., by backup engine 110 or other suitable logic) based on the entries of the storage backup log 500 for the file. Radio buttons are present next to the points in time allowing the user to select one of the backups from which the file may be restored (e.g., to its original location or to another location selected by the user), e.g., responsive to selection of button 612. The restoration portion 606 also displays the size of each file backup as well as the date on which the file was last modified at the source location. The date the file was last modified may be different from the date of the backup.

In some instances, only unique versions of the file are shown to the user in the multiple point-in-time file system explorer 600 (e.g., where the unique versions may be determined by entries for the file stored in the storage backup log 500). Thus, in the embodiment depicted, the versions available in the backups on Mar. 21, 2023 and Mar. 28, 2023 may be omitted in an alternative embodiment.

In other embodiments, any suitable information may additionally or alternatively be displayed in the multiple point-in-time file system explorer 600 responsive to the selection of a file or directory, whether displayed within restoration portion 606 or within another portion of the multiple point-in-time file system explorer 600. For example, the hashes or version numbers associated with the different versions of the files or the time the file or directory was created at the source may be displayed in some embodiments.

Multiple point-in-time file system explorer 600 may also allow for various filtering options to be applied to the files and directories that are displayed by the 600. For example, the user may be able to filter files or directories based on the creation time, updated time, deleted time, file size, or other suitable criteria.

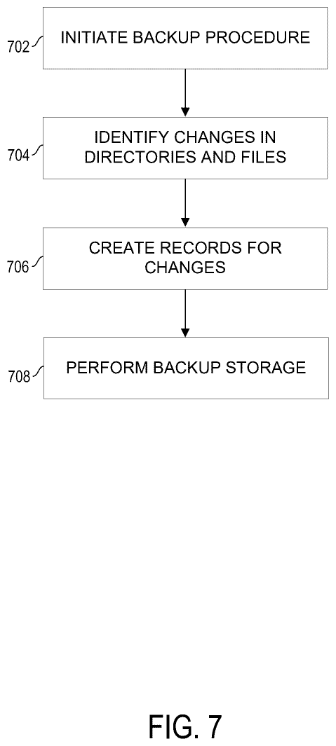

FIG. 7 illustrates a flow for updating a storage backup log for a multiple point-in-time file system explorer, in accordance with any of the embodiments disclosed herein. Operations of the flow may be performed by the backup engine 110, a backend 106, one or more computing devices 102, other suitable logic, and/or a combination thereof.

At 702, a backup procedure is initiated. The backup procedure may be initiated in response to reception of a storage backup request from a user of a computing devices 102, a scheduled backup for a previously entered backup request, or some other trigger. A storage backup request may identify a data collection comprising files and directories that are to be backed up. The collection may include at least a portion of at least one file system. The collection may include all or a portion of the files and directories stored by one or more physical machines, virtual machines, storage drives, server pools, or other storage collection of one or more computing devices.

At 704, the data collection is scanned to identify changes in files and directories since the last backup was performed on the data collection. Changes may include, e.g., addition or deletion of files or directories, updating of names or contents of files or directories, or changes in location of files or directories.

At 706, records are created for the changes. The records may be added to a storage backup log (e.g., 500 or a variation thereof) that is kept for backups of the data collection.

At 708, the data collection is backed up. For example, a full, incremental, or differential backup may be performed. In some instances, the backup engine 110 may perform the backup (e.g., by copying files to a backend 106). In other instances, some other logic (e.g., any suitable backup tool) may perform the backup.

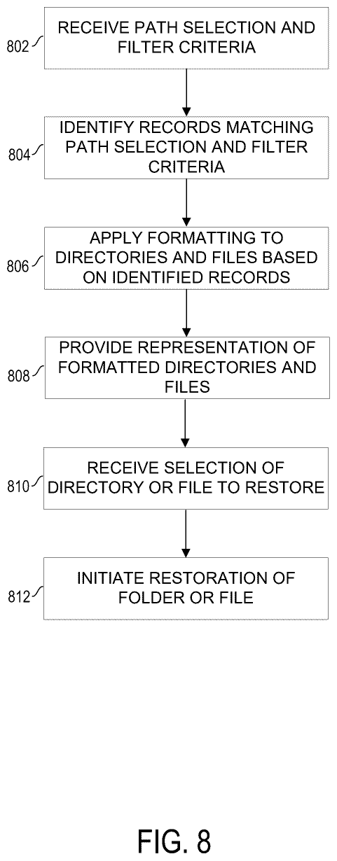

FIG. 8 illustrates a flow for providing a multiple point-in-time file system explorer, in accordance with any of the embodiments disclosed herein. Operations of the flow may be performed by the backup engine 110, a backend 106, one or more computing devices 102, other suitable logic, and/or a combination thereof.

At 802, a path selection and filter criteria are received. For example, a user may utilize a multiple point-in-time file system explorer (e.g., 402, 600, or variant thereof) executed on a computing device 102 to select a file path to view. The user may also specify one or more filter criteria. The filter criteria may include one or more of a reference point-in-time, a starting point-in-time, and ending point-in-time, creation time, updated time, deleted time, file size, or other suitable criteria.

At 804, records matching the path selection and the filter criteria are identified. In various embodiments, the records may be identified from a storage backup log 500. For example, these records may include information specifying which files and directories were included at that path in backups performed at various point-in-times. The information may also indicate that some of these files or directories were deleted prior to a reference point-in-time or created after the reference point-in-time.

At 806, formatting is applied to one or more directories and/or files based on the identified records. For example, a first format may be applied to files and directories existing at the reference point-in-time, a second format may be applied to files and directories that had been deleted prior to the reference point-in-time, and a third format may be applied to files and directories that were created after the reference point-in-time.

At 808, a representation of the formatted directories and files is provided. For example, the representation of the formatted directories and files may be provided by the data backup and search system 108 or other logic of cloud data backup environment 100 to a computing device 102 in any suitable format allowing the data backup and search system 108 to display the multiple point-in-time file system explorer. For example, the representation may be provided in HyperText Markup Language, JavaScript Object Notation, eXtensible Markup Language, JavaScript, or other suitable format. Similarly, such a representation may also be provided by circuitry of a computing device 102 (e.g., that receives the representation from data backup and search system 108 or generates a displayable representation based on information received from data backup and search system 108) to other circuitry of computing device 102 for display by the computing device 102.

At 810, a selection of a directory or a file to restore is received. For example, a user may select a version of the directory or file to restore from the multiple point-in-time file system explorer (e.g., by selecting the particular point-in-time of one of the backups of the directory or file). At 812, restoration of the directory or file is initiated. For example, the data backup and search system 108 may communicate with a backend 106 to cause the file or directory to be restored to the source or other location specified by a user.

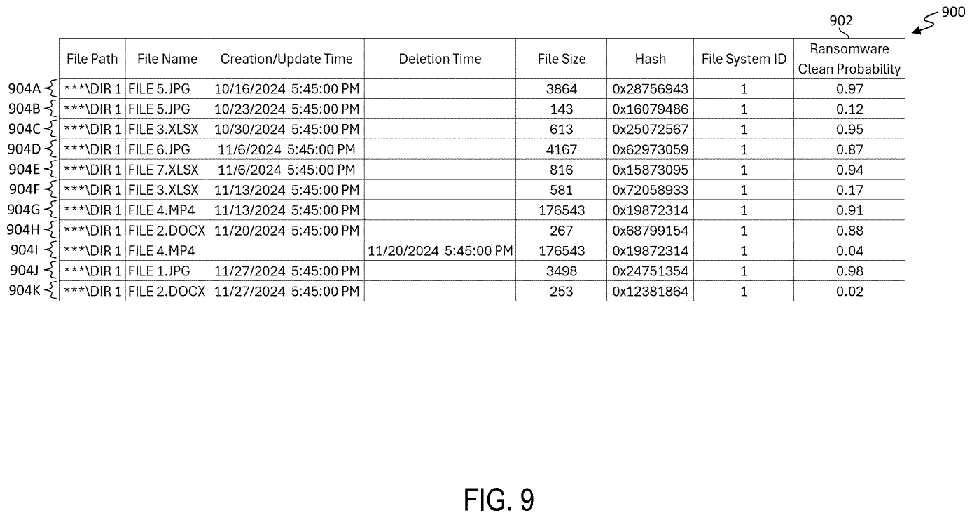

FIG. 9 illustrates a storage backup log 900 for a multiple point-in-time file system explorer for ransomware mitigation, in accordance with any of the embodiments disclosed herein. The storage backup log 900 may have any suitable characteristics of storage backup log 500, but in this embodiment the records also include values for a likelihood of whether the file is corrupt, embodied in FIG. 9 as a ransomware clean probability.

The ransomware clean probability 902 is a likelihood that the file referenced in that record is not corrupt (e.g., encrypted by ransomware), and thus may be an example of a probability of file non-corruption. In this embodiment, the ransomware clean probability 902 ranges between 0 and 1, with 0 indicating full probability that the file is corrupt and 1 indicating no probability that the file is corrupt. Other embodiments may use any suitable scoring system for the likelihood of corruption.

The ransomware clean probability 902 for a file may be determined, e.g., by the backup engine 110, other logic of data backup and search system 108, computing device 102, or other suitable logic of cloud data backup environment 100 in any suitable manner. For example, the 902 may be calculated based on the amount of change in the file relative to the last time the file was backed up, the amount of entropy of the file, a determination of whether the format of the content of the file matches the expected format of the file type extension (e.g., if the extension is .docx, a check is made to see whether the file conforms with typical .docx formatting), whether the file extension has changed (while the remainder of the file title remains the same), abnormal file size, whether a directory of the file includes a ransom note, whether the file is an initial version of a file, or other suitable determinations.

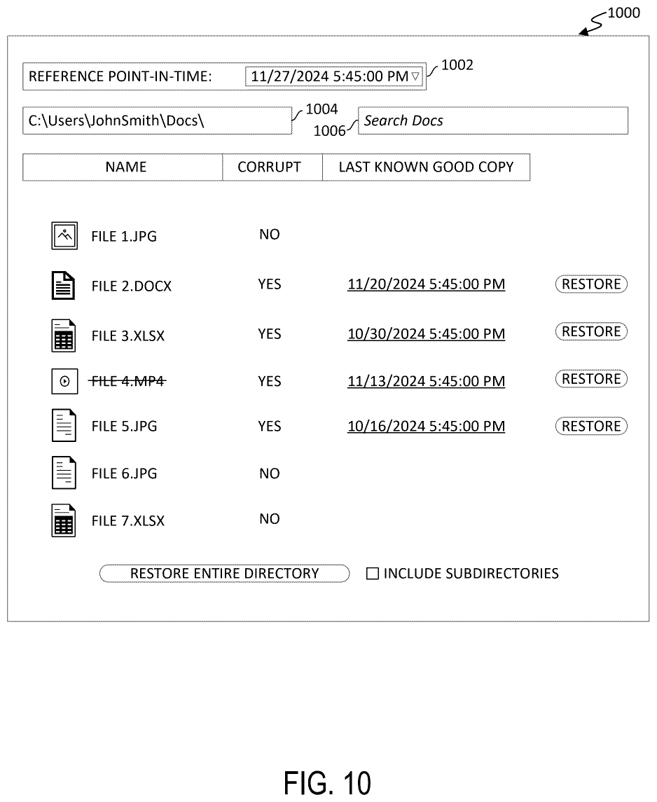

Storage backup log 900 includes a plurality of records that each have a ransomware clean probability 902. In some embodiments, some records may omit a ransomware clean probability 902. For example, if the record denotes a deletion of a file the ransomware clean probability 902 may be omitted. As an alternative (and as shown in the embodiment), a record corresponding to a deletion may include a ransomware clean probability 902 that indicates the likelihood that the deletion was caused by ransomware or other malicious software. For explanatory purposes, the first portion of the file paths in the record are abbreviated as ***. The records shown may be a portion of the records in the storage backup log 900 and are all for files within a directory at “C:\Users\JohnSmith\Docs\” (as shown in FIG. 10).

In various embodiments, a threshold value for the ransomware clean probability 902 may be used to determine whether the system will consider a file to be corrupt or not corrupt. The threshold may be set by the data backup and search system 108 or other suitable logic. In some instances, a user of a computing device 102 or an administrator of an organization may specify the threshold to be used (e.g., by entering it into an interface displayed by a computing device and transmitting it over a network to the data backup and search system 108).

In other embodiments, multiple thresholds may be used to classify the likelihood that the file is corrupt. For example, the data backup and search system 108 may use various thresholds to differentiate between highly likely to be corrupt, probably corrupt, maybe corrupt, probably not corrupt, and highly unlikely to be corrupt (and the multiple point-in-time file system explorer 1000 could display such indications). While the focus herein is on a system that performs a binary determination as to whether a file is corrupt based on a single threshold for a ransomware clean probability, the embodiments herein may be adapted to multiple levels of likelihood a file is corrupt or the determination of whether the file is corrupt may be made in any other suitable manner based on any of the factors listed above with respect to determining the ransomware clean probability or other suitable factors. For the examples of FIGS. 9-11 herein, a threshold of 0.2 will be used, wherein a score under 0.2 results in the file system explorer treating the file as corrupt and a score over 0.2 results in the file system explorer treating the file as not corrupt (in other words a good copy).

Record 904A indicates that in a first backup on Oct. 16, 2024, FILE 5.JPG is created (or updated). The ransomware clean probability of this record is 0.97, indicating that this file is not corrupt.

Record 904B indicates that in a second backup on Oct. 23, 2024, FILE 5.JPG is updated. The ransomware clean probability of this record is 0.12, indicating that this file is corrupt. Thus, the file may have been affected by ransomware between the first backup and the second backup.

Record 904C indicates that in a third backup on Oct. 30, 2024, FILE 3.XLSX is created (or updated). The ransomware clean probability of this record is 0.95, indicating that this file is not corrupt.

Record 904D indicates that in a fourth backup on Nov. 6, 2024, FILE 6.JPG is created (or updated). The ransomware clean probability of this record is 0.87, indicating that this file is not corrupt.

Record 904E indicates that in the fourth backup, FILE 7.XLSX is created (or updated). The ransomware clean probability of this record is 0.94, indicating that this file is not corrupt.

Record 904F indicates that in a fifth backup on Nov. 13, 2024, FILE 3.XLSX is updated. The ransomware clean probability of this record is 0.17, indicating that this file is corrupt.

Record 904G indicates that in the fifth backup, FILE 4.MP4 is created (or updated). The ransomware clean probability of this record is 0.91, indicating that this file is not corrupt.

Record 904H indicates that in a sixth backup on Nov. 20, 2024, FILE 2.DOCX is created (or updated). The ransomware clean probability of this record is 0.88, indicating that this file is not corrupt.

Record 904I indicates that in the sixth backup, FILE 4.MP4 is deleted. In this embodiment, a ransomware clean probability score is assigned to this record. In this embodiment, the score may be based on the probability that the deletion was caused by malicious software such as ransomware. This score may be determined based on any suitable factors, such as when the file was deleted, how the file was deleted (e.g., what process initiated the deletion), or other suitable factors. In this instance, the ransomware clean probability for the deletion is 0.04, indicating that the deletion was caused by malicious software.

Record 904J indicates that in a seventh backup on Nov. 27, 2024, FILE 1.JPG is created (or updated). The ransomware clean probability of this record is 0.98, indicating that this file is not corrupt.

Record 904K indicates that in the seventh backup, FILE 2.DOCX is updated. The ransomware clean probability of this record is 0.02 indicating that this file is corrupt.

FIG. 10 illustrates a multiple point-in-time file system explorer 1000 for ransomware mitigation, in accordance with any of the embodiments disclosed herein. The multiple point-in-time file system explorer 1000 may include any suitable characteristics of multiple point-in-time file system explorers 402 or 600.

The multiple point-in-time file system explorer 1000 includes an interface 1002 for entering a reference point-in-time. The reference point-in-time may function similarly to the reference point-in-time described earlier in connection with FIG. 6. In some embodiments, the reference point-in-time may default to the point-in-time of the most recent backup, but a different point-in-time may be selected by the user.

Multiple point-in-time file system explorer 1000 also includes an interface 1004 for a user to enter a file path and a search interface 1006 to enter search terms. The multiple point-in-time file system explorer 1000 displays files and/or directories matching the file path and/or the search terms entered by the user. In some embodiments, the information to display in multiple point-in-time file system explorer 1000 may be determined based on a backup log, such as storage backup log 900.

In the embodiment depicted, the multiple point-in-time file system explorer 1000 displays the names of the files and their extensions (matching the file path and/or search terms) as well as an indication of whether the latest version of the file that has been backed up is corrupt (e.g., in the backup occurring at the reference point-in-time or in the most recent backup in which the file was backed up prior to the reference point-in-time). If a file is detected as corrupt, an indication of the last known good copy (e.g., a point-in-time of a backup) of the file is also displayed.

As captured in the storage backup log 900, record 904J indicates that FILE 1.JPG is not corrupt. Record 904K indicates that the latest version of FILE 2.DOCX is corrupt. Record 904H is the most recent record for a creation or update of FILE 2.DOCX that indicates a good copy of the file, therefore the point-in-time of that record is listed in multiple point-in-time file system explorer 1000 as the last known good copy of FILE 2.DOCX.

Record 904F indicates that the latest version of FILE 3.XLSX is corrupt. Record 904C is the most recent record for a creation or update of FILE 3.XLSX that indicates a good copy, therefore the point-in-time of that record is listed in multiple point-in-time file system explorer 1000 as the last known good copy of FILE 3.XLSX.

FILE 4.MP4 was deleted prior to the backup on Nov. 27, 2024at the reference point-in-time, but may be displayed in the multiple point-in-time file system explorer 1000 based on the determination that the deletion may have been caused by malicious software (as indicated by the low ransomware clean probability 902 of record 904I. Because FILE 4.MP4 was not in existence as of the reference point-in-time, it may be shown in a format that is different from the other files. In this embodiment, the file is shown in strikethrough to indicate the prior deletion. In other embodiments, any suitable formatting may be used (e.g., a different color, one or more different effects, etc.). The multiple point-in-time file system explorer 1000 also shows the point-in-time of the last known good copy of the deleted file, which was Nov. 13, 2024 as indicated by record 904G.

Record 904B indicates that the latest version of FILE 5.JPG is corrupt, but record 904A indicates a good copy of FILE 5.JPG, therefore the point-in-time of that record is listed in multiple point-in-time file system explorer 1000 as the last known good copy of FILE 5.JPG.

The most recent record 904D for FILE 6.JPG indicates that FILE 6.JPG is not corrupt. Similarly, the most recent record 904E for FILE 7.XLSX indicates that FILE 7.XLSX is not corrupt. Accordingly, these files are both shown as not corrupt by multiple point-in-time file system explorer 1000.

In some embodiments, if a file is detected as corrupt, but no good copy is available in any of the backups, the multiple point-in-time file system explorer 1000 may indicate such in the display (e.g., through an informative message, a different formatting of the file name, or other suitable means). Thus, a user may be informed and may have the opportunity to browse one or more versions of the file to verify whether the versions are all indeed corrupt.

In various embodiments, the multiple point-in-time file system explorer 1000 may include any other suitable information for the files at the reference point-in-time and/or the point-in-time of the last known good copies. For example, the size or date of last modification of either (or both) the corrupt file and the last known good copy may be displayed.

In some embodiments, the multiple point-in-time file system explorer 1000 may include links (e.g., hyperlinks) to either version or both versions of the file at the reference point-in-time and at the time of the last known good copy, to enable the user to access the versions of the files to determine whether they are indeed corrupt.

The multiple point-in-time file system explorer 1000 also includes buttons next to the individual indications of the points in time of the last known good copies of the corrupt files. When one of these buttons is selected, a process to restore the corresponding file is initiated. The file may be restored in any suitable manner. In one embodiment, any versions of the file that have been backed up after the point-in-time of the last known good copy may be deleted from the backups. Additionally or alternatively, the corresponding records in the storage backup log 900 may be deleted so that as of the reference point-in-time, the last known good copy is referenced as the version in existence at the reference point-in-time. In various embodiments, the file(s) may be restored to their original location (e.g., at the source) or downloaded to a different location.

In the embodiment depicted, the multiple point-in-time file system explorer 1000 also includes an option to restore multiple files with a single selection. For example, a user may initiate restoration of the entire directory (with an option to include the restoration of last known good copies of corrupt files in the subdirectory of the current directory or just to include the files of the current directory). In some embodiments, the user may additionally or alternatively have an option to restore all corrupt files in the storage collection covered by the backups (e.g., an entire file system or a portion thereof).

In some instances, the multiple point-in-time file system explorer 1000 may include an option that when selected displays the various points in time of backups of a corrupt file so that the user may browse the versions of the file to determine which versions are corrupt and which version should be restored. The user may then select one of these versions and the system may initiate restoration of the file.

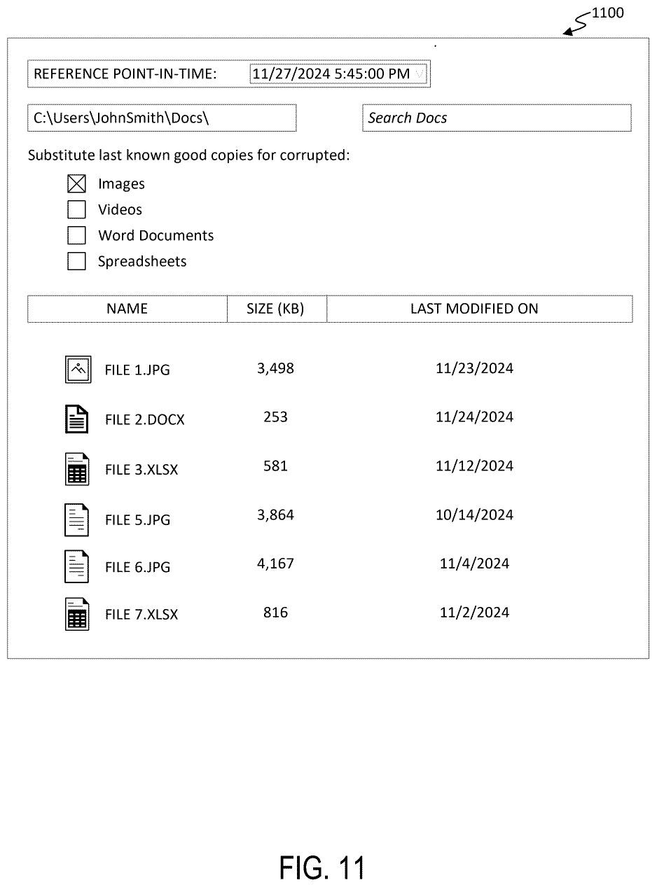

FIG. 11 illustrates a multiple point-in-time file system explorer 1100 with filters for ransomware mitigation, in accordance with any of the embodiments disclosed herein. The multiple point-in-time file system explorer 1100 may include any suitable characteristics of multiple point-in-time file system explorers 402, 600, or 1000.

In this embodiment, multiple point-in-time file system explorer 1100 includes a filter section 1102, enabling a user to select the types of files for which the last known good copies will be displayed if the latest version of the file is corrupt. The filters may be of a general type as shown. For example, selection of images may result in filtering for various types of images, such as .JPG, .PNG, .BMP, .PNG, etc., selection of word documents may result in filtering for various types of word documents, such as .DOCX., .DOC., .RTF., etc. Additionally or alternatively, a user may specify specific file type extensions for the filtering.

The files displayed in the multiple point-in-time file system explorer 1100 are based on the reference point-in-time, the file path, and the selected filtering. In this embodiment, the user has selected “Images” as the filtering option, such that for any image files within the file path C: \Users\JohnSmith\Docs\ that are detected as corrupt, the last known good copy of that file from a prior backup will be substituted for the version of the file at the reference point-in-time.

In the embodiment depicted, the latest versions (at the reference point-in-time) of the file types that are not selected in the filtering portion are all shown, regardless of whether the file is detected as corrupt or not. For the image files, the files in the path are each checked to see whether the version of the file at the reference point-in-time is corrupt or not. If the file is not corrupt, the version of the file in existence at the reference point-in-time is displayed by the 1100. If the file is corrupt, the most recent good copy of the file at a point-in-time prior to the reference point-in-time is displayed in place of the version of the file at the reference point-in-time.

In the embodiment depicted, FILE 1.JPG, FILE 5.JPG, and FILE 6.JPG are the files within the path that are images. The versions of FILE 1.JPG and FILE 6.JPG at the reference point-in-time are not corrupt (as indicated by records 904J and 904D) and thus the versions of these files as of the reference point-in-time are displayed. The most recent version of FILE 5.JPG as of the reference point-in-time is detected as corrupt as indicated by record 904B, so the version of FILE 5.JPG corresponding to the record 904A is displayed in the multiple point-in-time file system explorer 1100.

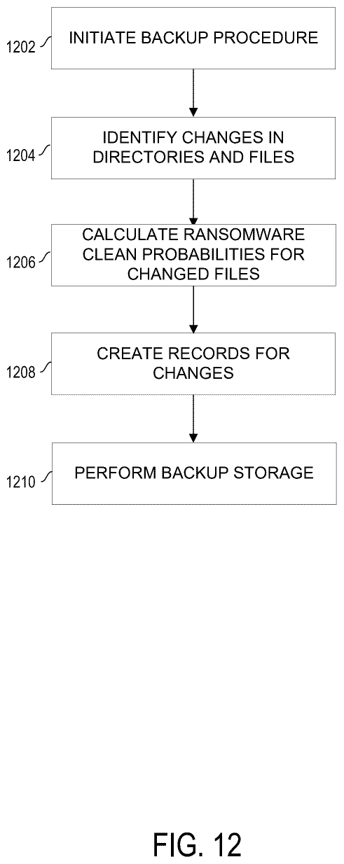

FIG. 12 illustrates a flow for updating a storage backup log for a multiple point-in-time file system explorer for ransomware mitigation, in accordance with any of the embodiments disclosed herein. Operations of the flow may be performed by the backup engine 110, a backend 106, one or more computing devices 102, other suitable logic, and/or a combination thereof.

At 1202, a backup procedure is initiated (e.g., in a manner similar to that described above with respect to operation 702). At 1204, the data collection is scanned to identify changes in files and directories since the last backup was performed on the data collection (e.g., in a manner similar to that described above with respect to operation 704).

At 1206, ransomware clean probabilities (or other suitable indications of the probabilities that the respective files are corrupt) are calculated for the files that were identified as new or updated at 1204. These probabilities may be calculated in any suitable manner, such as that described above.

At 1208, records are created for the changes. The records may be added to a storage backup log (e.g., 900 or a variation thereof) that is kept for backups of the data collection. The records may include the ransomware clean probabilities.

At 1210 the data collection is backed up (e.g., in a manner similar to that described above with respect to operation 708).

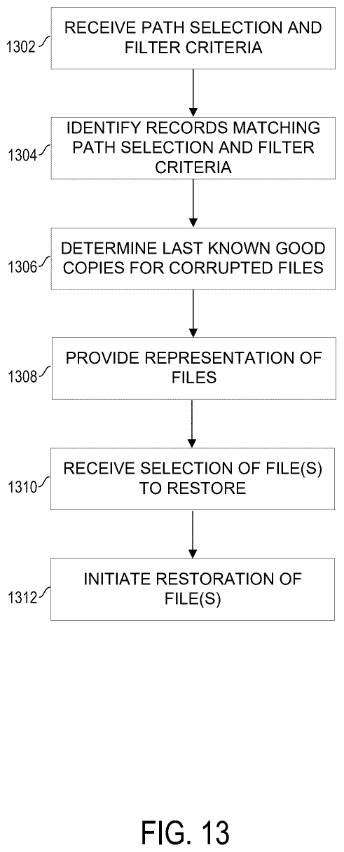

FIG. 13 illustrates a flow for providing a multiple point-in-time file system explorer for ransomware mitigation, in accordance with any of the embodiments disclosed herein. Operations of the flow may be performed by the backup engine 110, a backend 106, one or more computing devices 102, other suitable logic, and/or a combination thereof.

At 1302, a path selection and filter criteria are received. For example, a user may utilize a multiple point-in-time file system explorer (e.g., 1000, 1100, or variant thereof) executed on a computing device 102 to select a file path to view and/or to specify file search terms. The user may also specify a reference point-in-time. In various embodiments, the user could specify other filtering criteria such as a starting point-in-time of backups to be searched, a file creation time or range, a file updated time or range, a file deleted time or range, a file size or size range, or other suitable criteria that may be used to limit the results displayed by the file system explorer.

At 1304, records matching the path selection and the filter criteria are identified. In various embodiments, the records may be identified from a storage backup log 900. For example, these records may include information specifying which files and directories were included at that path at the reference point-in-time. These records may also indicate whether the files corresponding to the records are likely to be corrupt.

At 1306, the point in time of the backup of the last known good copy is determined for each of the files that are deemed to be corrupt (e.g., that have a ransomware clean probability below a threshold value). For example, the storage backup log 900 may be searched to identify the most recent version of the file prior to the reference point-in-time that has an acceptable ransomware clean probability (e.g., above a threshold value).

At 1308, a representation of the files is provided. For example, the representation of the files may be provided by the data backup and search system 108 or other logic of cloud data backup environment 100 to a computing device 102 (or by circuitry of the computing device 102 to other circuitry of the computing device 102) in any suitable format allowing the computing device 102 to display the multiple point-in-time file system explorer. For example, the representation may be provided in HyperText Markup Language, JavaScript Object Notation, eXtensible Markup Language, JavaScript, or other suitable format (e.g., pixel data for a graphic representation sent to a GPU). The representation may include, for example, names of the files, any suitable information about the files (e.g., sizes, date/time last modified, etc.) and the points in time of the last known good copies of the files for files that are corrupt at the reference point-in-time.

At 1310, a selection of one or more files to restore is received. For example, a user may select an option to restore the last known good copy of one or more of the corrupt files. At 1312, restoration of the selected file(s) is initiated. For example, the data backup and search system 108 may communicate with a backend 106 to cause the file(s) to be restored to the source or other location specified by a user.

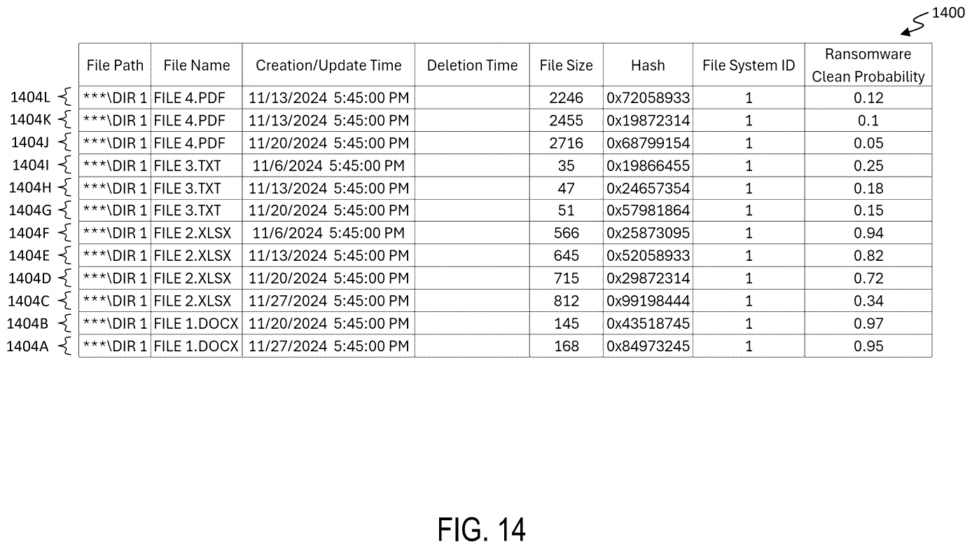

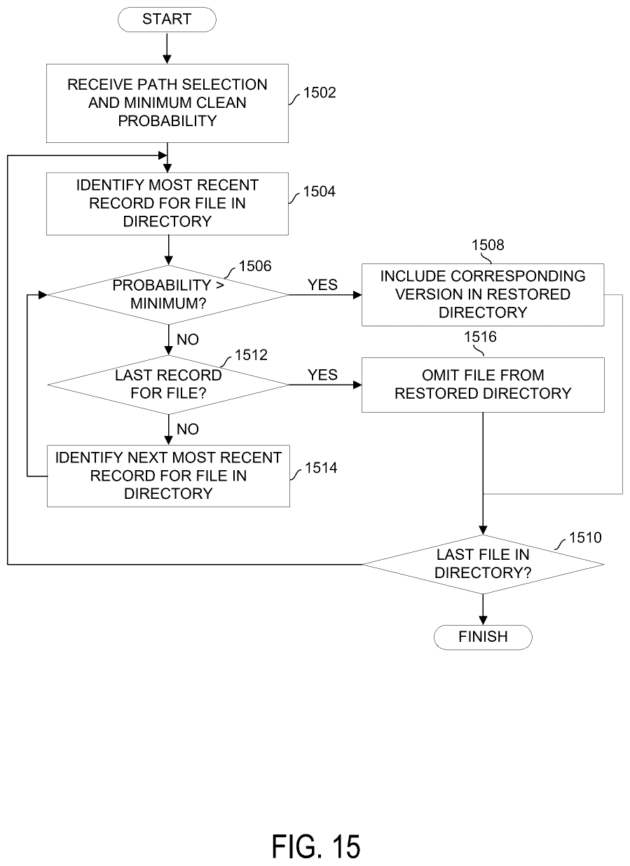

FIG. 14 illustrates a storage backup log 1400 for directory restoration for ransomware mitigation, in accordance with any of the embodiments disclosed herein. The storage backup log 1400 may have any suitable characteristics of storage backup log 500 or storage backup log 900 described above. In this embodiment, the order of the storage backup log 1400 is ordered primarily by filename and secondarily by creation/update time for explanatory purposes, whereas in other embodiments, the records may have any suitable order. In the example embodiment, various records are shown for files of a directory at the path “***\DIR 1”. The contents of the storage backup log 1400 will be described in more detail in connection with FIGS. 15-18.

FIG. 15 illustrates a flow for directory restoration based on a minimum clean probability, in accordance with any of the embodiments disclosed herein. Operations of the flow may be performed by the backup engine 110, a backend 106, one or more computing devices 102, other suitable logic, and/or a combination thereof.

At 1502, a path and a minimum clean probability are received (e.g., in a request). For example, a user may utilize a multiple point-in-time file system explorer (such as those described above) executed on a computing device 102 or may call an API from a computing device 102 (e.g., provided by data backup and search system 108) to provide these parameters. In various embodiments, the request may be sent over the network 104 in any suitable manner or format. For purposes of this example, the minimum clean probability is 0.75.

The path specifies a directory that is to be restored. The minimum clean probability specifies a threshold for a ransomware clean probability (e.g., a likelihood that a file is not corrupt, e.g., encrypted by ransomware) as described above. The ransomware clean probability indicates a minimum ransomware clean probability threshold for files that are to be included in the restored directory.

Responsive to the request, the data backup and search system 108 (or other suitable logic) will analyze the records of backups of files and for each file will check for the most recent version of the file that has a ransomware clean probability above the minimum clean probability. If such a version exists, this version will be included in the restored directory. If no such versions exist, then any suitable action may be taken. For example, the latest version of the file may be kept in the restored directory or the file may be omitted from the restored directory. In some embodiments, the action that is taken when no such versions exist is configured based on a selection by the user (e.g., provided to a computing device 102 via an interface that communicates with data backup and search system 108). In various embodiments, when the latest version of the file is kept because no versions are above the minimum clean probability, an indication that the latest version may not be clean is provided to the user (e.g., the indication may provide a visual indicator indicating such and/or may provide the ransomware clean probability of the version kept).

In various embodiments, the request may encompass all available backups of files of the directory at any points in time or a subset thereof. For example, the reference point-in-time of the restored directory may be the current time and all available backups may be included in the search for file versions that are above the minimum clean probability. As another example, the reference point-in-time of the restored directory may be the current time and the search for file versions that are above the minimum clean probability may be limited to records of backups that were after a specified time (and the time range may be specified by the user in the request for the restored directory). As another example, the reference point-in-time of the restored directory may be a time in the past (e.g., specified in the request) and the search may be limited to all records before that time or to records between a specified time earlier than the reference point-in-time and the reference point-in-time.

In various embodiments, the restoration of the directory may include restoration of all types of files within the directory or a subset thereof (e.g., the user may specify one or more file types to be restored in the request). In other embodiments, any other suitable filters may be applied to the files of the directory that are to be restored (e.g., any of the filter criteria listed above may be specified in the request).

The remaining portions of the flow of FIG. 15 represent an example flow for performing the directory restoration based on the minimum clean probability and will be described with respect to the records of the storage backup log 1400.

At 1504, a most recent record for a file in the directory is identified (in cases in which the restoration has a reference point-in-time that is earlier than the current point-in-time, then the most recent record that is equal to or precedes the reference point-in-time may be identified). For example, when FILE 1.DOCX is being analyzed for restoration, record 1404A is identified as corresponding to the most recent backup.

At 1506, a determination is made as to whether the ransomware clean probability of the record is greater than the minimum clean probability. If it is, then the corresponding version of the file is included in the restored directory at 1508. In various embodiments, this may not require any additional action (as the record may be the most recent record and thus may represent the current version for the directory). In an embodiment where the restoration is for a reference point-in-time prior to the current time, any records that are more recent than the record may be deleted. In some instances, an indication that the file is to be included in the restored directory may be generated and stored. Any other suitable actions may be taken to include the version of the file within the restored directory. In the embodiment depicted, the ransomware clean probability file indicated in record 1404A for FILE 1.DOCX is 0.95, which is greater than the minimum clean probability of 0.75, so the version of FILE 1.DOCX corresponding to record 1404A is included in the restored directory. The flow then moves to 1510 where a determination is made as to whether the file is the last file to be analyzed in the directory. If it is the last file, the flow finishes.

If it is not the last file, the flow returns to 1504, where the most recent record for the next file in the directory is identified. In this example, the next file is FILE 2.XLSX, and the most recent record for that file is record 1404C. At 1506, a determination is made that the ransomware clean probability of the record 1404C (0.34) is not greater than the minimum clean probability (0.75) and the flow moves to 1512 where a determination is made as to whether the record is the last record for the file. In this case, additional records (1404D, 1404E, and 1404F) exist, so the flow moves to 1514 where the next most recent record (record 1404D) for the file is identified. The flow returns to 1506 where the ransomware clean probability of this record is compared to the minimum clean probability. In this case, the record 1404D has a lower ransomware clean probability (0.72) than the minimum clean probability (0.75). Accordingly, the flow moves to 1512 and a determination is made that this is not the last record for the file and then the next most recent record (record 1404E) is identified for the file at 1514. At 1506, a determination is made that the ransomware clean probability (0.82) of record 1404E is greater than the minimum clean probability (0.75) and thus the version of FILE 2.XLSX that corresponds to record 1404E is included in the restored directory at 1508. In some embodiments, this may include deleting the records that are more recent than the selected record and/or generating and storing an indication that the version of the file is to be included in the restored directory. In some instances, the restoration of the directory may include overwriting the file at the source storage location with the version that is in the restored directory. In various embodiments, including the corresponding version in the restored directory may comprise any suitable action, such as any of those described in the above flows with respect to restoring a version of a file. At 1510, a determination is made that at least one additional file is present in the directory and the flow returns to 1504.

At 1504, the most recent record for the next file in the directory is identified. In this example, the next file is FILE 3.TXT, and the most recent record for that file is record 1404G. As the flow iterates, it is determined that each record (1404G, 1404H, and 1404I) have ransomware clean probabilities that are lower than the minimum clean probability. Accordingly, once the flow checks the last record and it is determined at 1512 that this is the last record, the flow moves to 1516 where the file may be omitted from the restored directory (alternatively, the most recent version of the file corresponding to record 1404G could be included in the restored directory). The flow moves to 1510 and then back to 1504.

At 1504, the most recent record for the next file in the directory is identified. In this example, the next file is FILE 4.PDF, and the most recent record for that file is record 1404J. As the flow iterates, it is determined that all of the records (1404J, 1404K, and 1404L) have ransomware clean probabilities that are lower than the minimum clean probability. Accordingly, once the flow checks the last record and it is determined at 1512 that this is the last record, the flow moves to 1516, where the file is omitted from the restored directory (alternatively, the most recent version of the file could be included in the restored directory). As this is the last file in the directory, the flow then ends.

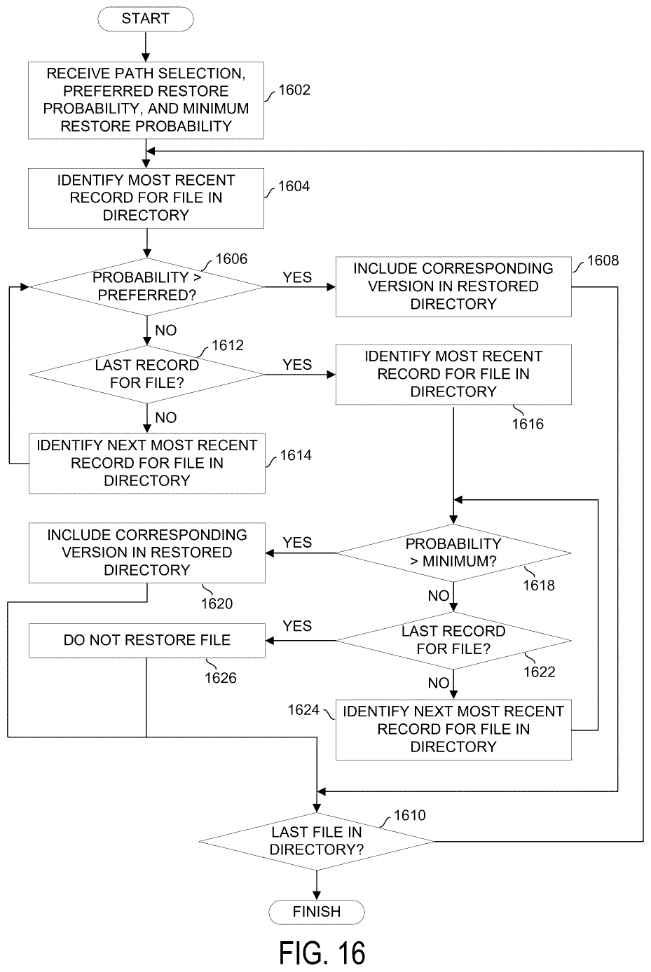

FIG. 16 illustrates a flow for directory restoration based on a preferred restore probability and a minimum restore probability, in accordance with any of the embodiments disclosed herein. Operations of the flow may be performed by the backup engine 110, a backend 106, one or more computing devices 102, other suitable logic, and/or a combination thereof.

At 1602, a path, a preferred restore probability, and a minimum restore probability are received. For example, a user may utilize a multiple point-in-time file system explorer (such as those described above) executed on a computing device 102 or may call an API from a computing device 102 (e.g., provided by data backup and search system 108) to provide these parameters. For purposes of this example, the preferred restore probability is 0.8 and the minimum restore probability is 0.2.

The path specifies a directory that is to be restored. The preferred restore probability and the minimum restore probability each specify a threshold for a ransomware clean probability (e.g., a likelihood that a file is not corrupt, e.g., encrypted by ransomware) as described above. The preferred restore probability indicates the preferred ransomware clean probability threshold for files that are to be included in the restored directory, while the minimum restore probability indicates the minimum ransomware clean probability threshold for files to be included in the restored directory.

Responsive to the path, preferred restore probability, and minimum restore probability, the data backup and search system 108 (or other suitable logic) will analyze the records of backups of files and for each file will check for the most recent version of the file that has a ransomware clean probability above the preferred restore probability. If such a version exists, this version will be included in the restored directory. If none of the backups are above the preferred restore probability, then the records may be checked to find the most recent version of the file that has a ransomware clean probability above the minimum restore probability. If no such records exist (indicating that none of the versions are above the minimum restore probability), then any suitable action may be taken. For example, the latest version of the file may be kept in the restored directory or the file may be omitted from the restored directory.

In various embodiments, the search may encompass all available backups or a subset thereof. For example, the reference point-in-time of the restored directory may be the current time and all available backups may be included in the search for file versions that are above the preferred restore probability and minimum restore probability. As another example, the reference point-in-time of the restored directory may be the current time and the search for file versions that are above the preferred restore probability and minimum restore probability may be limited to records of backups that were after a specified time (which could also be specified by the user in the request for the restored directory). As another example, the reference point-in-time of the restored directory may be a time in the past (specified in the request) and the search may be limited to all records before that time or to records between a specified time earlier than the reference point-in-time and the reference point-in-time.

In various embodiments, the restoration of the directory may include restoration of all types of files within the directory or a subset thereof (e.g., the user may specify one or more file types to be restored in the request). In other embodiments, any other suitable filters may be applied to the files of the directory that are to be restored (e.g., any of the filter criteria listed above).

The remaining portions of the flow of FIG. 16 represent an example flow for performing the directory restoration based on the preferred restore probability and minimum restore probability and will be described with respect to the records of the storage backup log 1400.

At 1604, a most recent record for a file in the directory is identified (in cases in which the restoration has a reference point-in-time that is earlier than the current point-in-time, then the most recent record that is equal to or precedes the reference point-in-time may be identified). For example, when FILE 1.DOCX is being analyzed for restoration, record 1404A is identified as corresponding to the most recent backup.

At 1606, a determination is made as to whether the ransomware clean probability of the record is greater than the preferred restore probability. If it is, then the corresponding version of the file is included in the restored directory. In various embodiments, this may not require any additional action (as the record may be the most recent record and thus may represent the current version for the directory). In an embodiment where the restoration is for a reference point-in-time prior to the current time, any records that are more recent than the record may be deleted. Any other suitable actions may be taken to include the version of the file within the restored directory. In the embodiment depicted, the ransomware clean probability file indicated in record 1404A for FILE 1.DOCX is 0.95, which is greater than the preferred restore probability of 0.8, so the version of FILE 1.DOCX corresponding to record 1404A is included in the restored directory. The flow then moves to 1610 where a determination is made as to whether the file is the last file to be analyzed in the directory. If it is the last file, the flow finishes.

If it is not the last file, the flow returns to 1604, where the most recent record for the next file in the directory is identified. In this example, the next file is FILE 2.XLSX, and the most recent record for that file is record 1404C. At 1606, a determination is made that the ransomware clean probability of the record 1404C is not greater than the preferred restore probability and the flow moves to 1612 where a determination is made as to whether the record is the last record for the file. In this case, additional records (1404D, 1404E, and 1404F) exist, so the flow moves to 1614 where the next most recent record (record 1404D) is identified. The flow returns to 1606 where the ransomware clean probability of this record is compared to the preferred restore probability. In this case, the record 1404D has a lower ransomware clean probability (0.72) than the preferred restore probability (0.8). Subsequently, a determination is made that this is not the last record for the file at 1612 and then the next most recent record (record 1404E) is identified for the file at 1614. At 1606, a determination is made that the ransomware clean probability (0.82) of record 1404E is greater than the preferred restore probability and thus the version of FILE 2.XLSX that corresponds to record 1404E is included in the restored directory at 1608. In some embodiments, this may include deleting the records that are more recent than the selected record and/or storing an indication that the particular record corresponds to the version of the file to be included in the restored directory. Additionally, the file could be overwritten at the source with the version that is in the restored directory. In various embodiments, including the corresponding version in the restored directory may comprise any suitable action, such as any of those described above with respect to restoring a version of a file. At 1610 a determination is made that at least one additional file is present in the directory and the flow returns to 1604.

At 1604, the most recent record for the next file in the directory is identified. In this example, the next file is FILE 3.TXT, and the most recent record for that file is record 1404G. As the flow iterates, it is determined that each record (1404G, 1404H, and 1404I) have ransomware clean probabilities that are lower than the preferred restore probability. Accordingly, once the flow checks the last record and it is determined at 1612 that this is the last record, the flow moves to 1616 where the most recent record (1404G) is again identified. At 1618 a determination is made as to whether the ransomware clean probability of the record (0.15) is greater than the minimum restore probability (0.2 in this case). As it is not, the flow moves to 1622 where a determination as to whether this record is the last record for the file. Since other records (1404H, 1404I) are present, the flow moves back to 1618. During the flow iteration it is also determined that the record 1404H has a ransomware clean probability that is lower than the minimum restore probability, but that record 1404I has a ransomware clean probability (0.25) that is greater than the minimum restore probability. Accordingly, the flow moves to 1620 after this determination, where the version of the file (FILE 3.TXT) that corresponds to record 1404I is included in the restored directory. The flow moves to 1610 and then back to 1604.

At 1604, the most recent record for the next file in the directory is identified. In this example, the next file is FILE 4.PDF, and the most recent record for that file is record 1404J. As the flow iterates, it is determined that each record (1404J, 1404K, and 1404L) have ransomware clean probabilities that are lower than the preferred restore probability. Accordingly, once the flow checks the last record and it is determined at 1612 that this is the last record, the flow moves to 1616 where the most recent record (1404J) is again identified. As the flow iterates, it is determined that each record (1404J, 1404K, and 1404L) also have ransomware clean probabilities that are lower than the minimum restore probability. Thus, the flow moves to 1626 where the file is not restored. In various embodiments (e.g., based on user configuration), this may result in the file not being included in the restored directory or in the most current version of the file remaining in the restored directory. In various embodiments, when the most current version of the file is kept because no versions are above the minimum restore probability, an indication that the latest version may not be clean is provided to the user (e.g., the indication may provide a visual indicator indicating such and/or may provide the ransomware clean probability of the version kept). As this is the last file in the directory, the flow then ends.

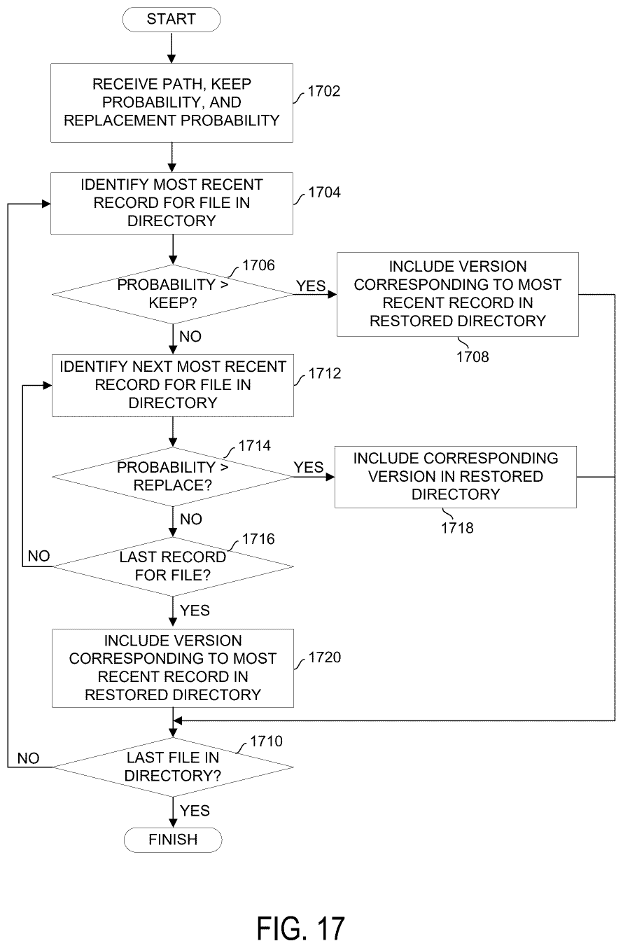

FIG. 17 illustrates a flow for directory restoration based on a keep probability and a replacement probability, in accordance with any of the embodiments disclosed herein. Operations of the flow may be performed by the backup engine 110, a backend 106, one or more computing devices 102, other suitable logic, and/or a combination thereof.

At 1702, a path, keep probability, and replacement probability are received. For example, a user may utilize a multiple point-in-time file system explorer (such as those described above) executed on a computing device 102 or may call an API from a computing device 102 (e.g., provided by data backup and search system 108) to provide these parameters. For purposes of this example, the keep probability is 0.5 and the replacement probability is 0.8.

The path specifies a directory that is to be restored. The keep probability and replacement probability each specify a threshold for a ransomware clean probability as described above. The keep probability indicates the ransomware clean probability threshold for replacing files that are in the directory with previous versions of the files that are above the threshold set by the replacement probability.

Responsive to a request comprising the path, keep probability, and replacement probability, the data backup and search system 108 (or other suitable logic) will analyze the records of backups of files and, for each file, will check to see if the ransomware clean probability of the most recent version of the file is higher than the keep probability. If it is, then the most recent version of the file will be kept. If it is not, then the most recent version of the file is replaced by the most recent backed up version of the file that has a ransomware clean probability higher than the replacement probability. If no such file exists, then the most recent version of the file is not replaced (or the file could be omitted from the restored directory).

In various embodiments, the records considered during the directory restoration may encompass all available backups or a subset thereof. For example, the reference point-in-time of the restored directory may be the current time and all available backups may be included in the search for file versions that are above the replacement probability (where the searches are performed for file versions at the reference point-in-time that are below the keep probability). As another example, the reference point-in-time of the restored directory may be the current time and the search for file versions that are above the replacement probability may be limited to records of backups that were after a specified time (which could also be specified by the user in the request for the restored directory). As another example, the reference point-in-time of the restored directory may be a time in the past (specified in the request) and the search for file versions above the replacement probability may be limited to all records before that time or to records between a specified time earlier than the reference point-in-time and the reference point-in-time.

In various embodiments, the restoration of the directory may include restoration of all types of files within the directory or a subset thereof (e.g., the user may specify one or more file types to be restored in the request). In other embodiments, any other suitable filters may be applied to the files of the directory that are to be restored (e.g., any of the filter criteria listed above).

The remaining portions of the flow of FIG. 17 represent an example flow for performing the directory restoration based on the keep probability and the replacement probability and will be described with respect to the records of the storage backup log 1400.

At 1704, a most recent record for a file in the directory is identified (in cases in which the restoration has a reference point-in-time that is earlier than the current point-in-time, then the most recent record that is equal to or precedes the reference point-in-time may be identified). For example, when FILE 1.DOCX is being analyzed during the restoration process, record 1404A is identified as corresponding to the most recent version of the file.

At 1706, a determination is made as to whether the ransomware clean probability of the version of the file corresponding to the record is greater than the keep probability. If it is, then the flow moves to 1708 and the version corresponding to the most recent record (e.g., the current version of the file) is included in the restored directory. In this example, the ransomware clean probability specified in record 1404A (0.95) is higher than the keep probability (0.5), therefore the version corresponding to record 1404A is included in the restored directory. The flow then moves to 1710 where a determination is made as to whether this is the last file in the directory. Because there are additional files in the directory, the flow moves to 1704.

At 1704, the most recent record for the next file is identified. For example, record 1404C for FILE 2.XLSX is identified. At 1706, the ransomware clean probability of the record is compared against the keep probability. As the ransomware clean probability of the record 1404C (0.34) is lower than the keep probability (0.5), the flow moves to 1712, where the next most recent record for the file is identified. In this instance, record 1404D for FILE 2.XLSX is identified. At 1714, a determination is made as to whether the ransomware clean probability of the record is greater than the replacement probability. In this instance, the ransomware clean probability of record 1404D is 0.72, which is lower than the replacement probability of 0.8, so the flow moves to 1716, where a determination as to whether one or more additional records are present for the file. Since at least one additional record (1404E, 1404F) are present, the flow moves back to 1712, where the next most recent record for the file is identified. In this instance, this record is 1404E. At 1714, it is determined that the ransomware clean probability of this record is 0.82, which is higher than the replacement probability of 0.8, therefore the flow moves to 1718, where the version of the file corresponding to this record is included in the restored directory. This operation may include any suitable actions such as those described above (e.g., with respect to operations 1508, 1608, or 1620). The flow then moves to 1710 and then returns to 1704 to process the remaining files. The most recent backups of FILE 3.TXT and FILE 4.PDF both have ransomware clean probabilities below the keep probability, but none of the other versions of these files have ransomware clean probabilities above the replacement probability, so for each file the flow reaches 1720, where the versions corresponding to the most recent records (1404G and 1404J) are included in the restored directory. In various embodiments, when the version corresponding to the most recent record of the file is kept because no versions are above the replacement probability, an indication that the version may not be clean is provided to the user (e.g., the indication may provide a visual indicator indicating such and/or may provide the ransomware clean probability of the version kept). The flow then ends.

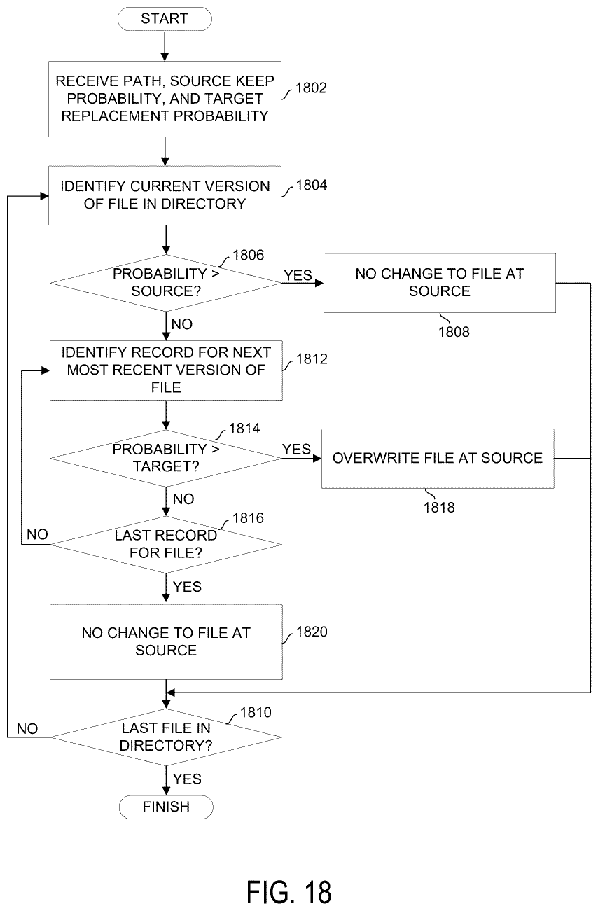

FIG. 18 illustrates a flow for in place directory restoration based on a source keep probability and a target replacement probability, in accordance with any of the embodiments disclosed herein. Operations of the flow may be performed by the backup engine 110, a backend 106, one or more computing devices 102, other suitable logic, and/or a combination thereof. The flow largely tracks the operation of FIG. 17. Operations of FIG. 18 may have any suitable characteristics of corresponding operations of FIG. 17 and thus a detailed description of some of these operations will be omitted below.

In the flow of FIG. 18, a directory is restored in place at the source storage location. In various embodiments, the source storage location may be part of any suitable computing device that is separate from one or more computing device that stores backups of the directory. For example, the source storage location may be present in a computing device 102 or other suitable computing logic.

In this flow, the path of the directory, a source keep probability, and a target replacement probability are received at 1802. In this instance, the path of the directory may identify a directory at a source (as well as the corresponding directory that is backed up). At 1804, a current version of a file is identified in the directory. At 1806, a determination is made as to whether a ransomware clean probability of the current version of the file is greater than the source keep probability. This may be made by referring to the ransomware clean probability in a record corresponding to the current version of the file or in other suitable manner (e.g., by calculating the ransomware clean probability dynamically either at the source or by the data backup and search system 108). If the ransomware clean probability of the current version of the file is greater than the source keep probability, then no change is made to the file at the source at 1808 and the flow moves to 1810 and then back to 1804 for the next file. If the ransomware clean probability of the current version of the file is not greater than the source keep probability, then the flow moves to 1812, where the record for the next most recent version of the file (corresponding to a backed up version of the file) is identified at 1812. At 1814, a determination is made as to whether the ransomware clean probability of this version of the file is greater than the target replacement probability. If it is, then this version of the file is retrieved from a backup storage location and is used to overwrite the file at the source storage location. In some embodiments, the storage backup log may also be updated to reflect that this version is now the most current version (e.g., by removing any records of versions that are more recent than the version used to overwrite the file at the source or otherwise providing an indication that this record corresponds to the most current version). If the ransomware clean probability of this version of the file is not greater than the target replacement probability, then the flow moves to 1816 and iterates back to 1812 until all the records for the file have been checked. If none of these records have a ransomware clean probability greater than the target replacement probability, then no change is made to the file at the source 1820 and the flow moves to 1810 and repeats until the last file of the directory is processed, at which point the flow ends.

In various embodiments, any of the flows above may include generating a representation of the restored directory (e.g., in conjunction with or separate from restoring the directory). For example, a representation of the restored directory may be generated based on the decisions as to which versions to include in the restored directory. Generating a representation of a restored directory may include generating any suitable information that may be used to restore the directory or to otherwise indicate the contents of the restored directory. For example, the representation may include records or other information indicating which versions of files of the directory are to be included in the restored directory. In some instances, generating the representation of the restored directory may include modification to or preservation of preexisting records corresponding to various versions of the files in the directory. For example, for a particular file where the most recent version is kept, the records for that file may be preserved, whereas for a file where a most recent version is replaced by a previous version, one or more records corresponding to versions more recent than the version that is kept may be deleted or otherwise marked as invalid (or a special indication may be associated with the record of the version that is kept to indicate that this version is the restored version). Other examples of representations of the restored directory may include a list of the versions of the files of the restored directory (or a subset thereof), the restored files themselves (or a subset thereof), locations of the versions to be restored (or a subset thereof), a list of files that do not need to be restored (e.g., for versions that are kept), or any suitable combination thereof. As another example, the representation may be in any suitable format allowing a file system explorer to display the restored directory (e.g., as described above with respect to 808 or 1308).

Any of the above flows 15-18 or variants thereof may be used to restore a directory in-place at the source storage location and/or to a different location. In some embodiments, the request may specify whether the restoration is to take place at the source storage location, at the backup storage location, at a different storage location (e.g., the restored directory and its files could be communicated to a different computing device), or a combination thereof (e.g., at both the source storage location and the backup storage location). In some embodiments, the request for directory restoration could also include an identifier (e.g., machine name, network address, etc.) of a storage location at which the directory is to be restored.

When a directory is restored in-place at the source storage location, the data backup and search system 108 or other logic may provide (e.g., to a computing device 102 or other logic associated with the source storage location) any suitable information to facilitate the restoration. For example, the data backup and search system 108 or other logic may provide indications of which files may be kept and indications of which files should be replaced with other versions. In some instances, the data backup and search system 108 may provide the file contents of the versions that are to replace files at the source storage location (or other identifying information about the files to enable the files to be sent to the source storage location).

It is important to note that the operations in FIGS. 7-8, 12-13, and 15-18 illustrate only some of the possible scenarios that may be executed by, or within, the various components of the systems described herein. Some of these operations may be removed or repeated where appropriate, or these steps may be modified or changed considerably without departing from the scope of the present disclosure. In addition, the timing of these operations may be altered considerably. For example, operations may occur in different orders or multiple operations may be performed in parallel. The preceding operational flows have been offered for purposes of example and discussion. In various embodiments, any suitable characteristics described with respect to an operation of one of these flows may be applied to a similar operation of another of these flows.

Logic can be used to implement the functionality of various components or to carry out the operations of the flows described herein. “Logic” may refer to hardware, firmware, software, or any combination of these to perform one or more functions. In some embodiments, logic may include a microprocessor or other processing elements capable of executing software instructions, discrete logic such as an application-specific integrated circuit (ASIC), a programmable logic device like a field-programmable gate array (FPGA), a storage device with recorded instructions, combinations of logic devices (e.g., on a printed circuit board), or other suitable hardware and software configurations. Logic may also include gates or other circuit components. In certain cases, logic may be entirely implemented as software. This software can take the form of packages, code, instruction sets, or data stored on a non-transitory computer-readable storage medium.

The embodiments of methods, hardware, software, firmware, or code described above may be implemented through instructions or code stored on a machine-accessible, machine-readable, computer-accessible, or computer-readable medium that can be executed by a processing element. A non-transitory machine-readable medium may refer to a mechanism that provides (e.g., stores and/or transmits) information in a format readable by a machine, such as a computer or electronic system. Examples of such non-transitory media include random-access memory (RAM), such as static RAM (SRAM) or dynamic RAM (DRAM); read-only memory (ROM); magnetic or optical storage media; flash storage devices; electrical and optical storage devices; acoustical storage devices; and other forms of storage devices that retain information obtained from transitory (propagated) signals (e.g., carrier waves, infrared signals, digital signals). These non-transitory media are distinct from the transitory signals themselves, which may provide information to the storage media.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. For example, the phrase “A and/or B” means (A), (B), or (A and B), while the phrase “A, B, and/or C” means (A), (B), (C), (A and B), (A and C), (B and C), or (A, B, and C).

As used throughout this description, and in the claims, a list of items joined by the term “at least one of” or “one or more of” can mean any combination of the listed terms.

What is claimed is:

1. A method, comprising:
receiving a request to restore a directory of a file system, the directory comprising a plurality of files, the request comprising a threshold for a probability of file non-corruption;
selecting versions of the plurality of files of the directory based on the threshold and probabilities of file non-corruption of the versions of the plurality of files at multiple points in time; and
generating a representation of a restored version of the directory, wherein the restored version of the directory includes the selected versions of the plurality of files.

2. The method of claim 1, further comprising, for a first file of the plurality of files, selecting a version of the first file for inclusion in the restored version of the directory based on a determination that a probability of file non-corruption of the version of the first file is greater than the threshold.

3. The method of claim 2, wherein selecting the version of the first file for inclusion in the restored version of the directory is further based on a determination that a more recent version of the first file has a probability of file non-corruption that is not greater than the threshold.

4. The method of claim 2, further comprising, for a second file of the plurality of files, selecting a version of the second file for inclusion in the restored version of the directory based on a determination that a probability of file non-corruption of the version of the second file is not greater than the threshold but is greater than a second threshold included in the request.

5. The method of claim 1, further comprising, for a first file of the plurality of files, selecting a first version of the first file from among a plurality of versions of the first file based on a determination that the plurality of versions of the first file each have a probability of file non-corruption that is not greater than the threshold and that the first version of the first file has a probability of file non-corruption that is greater than a second threshold included in the request.

6. The method of claim 5, wherein the threshold is greater than the second threshold.

7. The method of claim 1, further comprising comparing, for each of a plurality of versions of a file of the plurality of files, a probability of file non-corruption of the respective version of the file to a second threshold responsive to a determination that a probability of file non-corruption of a current version of the file is not greater than the threshold.

8. The method of claim 7, wherein the second threshold is greater than the threshold.

9. The method of claim 1, further comprising maintaining a storage backup log comprising a plurality of records, wherein a record corresponds to a version of a file and includes a probability of file non-corruption for the corresponding version.

10. The method of claim 9, wherein a record further includes a point-in-time of a backup for the corresponding version.

11. An apparatus comprising:
a communication interface to receive a request to restore a directory of a file system, the directory comprising a plurality of files, the request comprising a threshold for a probability of file non-corruption; and
at least one processor to:
select versions of the plurality of files of the directory based on the threshold and probabilities of file non-corruption of the versions of the plurality of files at multiple points in time; and
generate a representation of a restored version of the directory, wherein the restored version of the directory includes the selected versions of the plurality of files.

12. The apparatus of claim 11, wherein the request further specifies a time range of backups and wherein versions of the plurality of files considered for inclusion in the restored version of the directory are limited based on the time range.

13. The apparatus of claim 11, the at least one processor further to, for a first file of the plurality of files, select a version of the first file for inclusion in the restored version of the directory based on a determination that a probability of file non-corruption of the version of the first file is greater than the threshold.

14. The apparatus of claim 13, wherein selecting the version of the first file for inclusion in the restored version of the directory is further based on a determination that a more recent version of the first file has a probability of file non-corruption that is not greater than the threshold.

15. The apparatus of claim 11, the at least one processor further to:
compare, for each of a plurality of versions of a file of the plurality of files, a probability of file non-corruption of the respective version of the file to a second threshold responsive to a determination that a probability of file non-corruption of a current version of the file is not greater than the threshold; and
provide an indication of a selected version of the file to be used to overwrite the current version of the file at a source storage location.

16. At least one computer-readable non-transitory media comprising one or more instructions that when executed by at least one processor configure the at least one processor to cause performance of operations comprising:
receiving a request to restore a directory of a file system, the directory comprising a plurality of files, the request comprising a threshold for a probability of file non-corruption;
selecting versions of the plurality of files of the directory based on the threshold and probabilities of file non-corruption of the versions of the plurality of files at multiple points in time; and
generating a representation of a restored version of the directory, wherein the restored version of the directory includes the selected versions of the plurality of files.

17. The at least one media of claim 16, the operations further comprising, for a first file of the plurality of files, selecting a version of the first file for inclusion in the restored version of the directory based on a determination that a probability of file non-corruption of the version of the first file is greater than the threshold.

18. The at least one media of claim 17, wherein selecting the version of the first file for inclusion in the restored version of the directory is further based on a determination that a more recent version of the first file has a probability of file non-corruption that is not greater than the threshold.

19. The at least one media of claim 17, the operations further comprising, for a second file of the plurality of files, select a version of the second file for inclusion in the restored version of the directory based on a determination that a probability of file non-corruption of the version of the second file is not greater than the threshold but is greater than a second threshold included in the request, wherein generating the representation of the restored version of the directory comprises overwriting a current version of the second file at a source storage location with the selected version of the second file obtained from a backup storage location.

20. The at least one media of claim 16, the operations further comprising comparing, for each of a plurality of versions of a file of the plurality of files, a probability of file non-corruption of the respective version of the file to a second threshold responsive to a determination that a probability of file non-corruption of a current version of the file is not greater than the threshold.
